(19) United States
(12) Patent Application Publication
(10) Pub. No.: US 2017/0140307 A1
(43) Pub. Date: May 18, 2017

(54) PLAN MODELING AND TASK MANAGEMENT

(71) Applicant: o9 Solutions, Inc., Dallas, TX (US)

(72) Inventors: Chakri Gottemukkala, Austin, TX (US); Umesh Arasu, Coppell, TX (US); Koustuv Chatterjee, San Ramon, CA (US); Raghav Ranganathan, New York, NY (US)

(21) Appl. No.: 14/752,774

(22) Filed: Jun. 26, 2015

Related U.S. Application Data
(60) Provisional application No. 62/018,404, filed on Jun. 27, 2014.

(51) Int. Cl. G06Q 10/06

(52) U.S. Cl. CPC G06Q 10/067; G06Q 10/06311

(57) ABSTRACT

A task management platform is provided to identify task data stored in memory of a computing device, the task data describing a task assigned to at least one person in an organization. A relationship is determined between the task and a business entity modeled in one or more particular software-based business models in a set of business models. The task data is associated with the particular business model.

### CROSS-REFERENCE TO RELATED APPLICATIONS

This application claims benefit to U.S. Provisional Patent Application Ser. No. 62/018,404, filed Jun. 27, 2014, which is incorporated by reference herein in its entirety.

### TECHNICAL FIELD

This disclosure relates in general to the field of computer software modeling and, more particularly, to task management associated with business modeling.

### BACKGROUND

Modern enterprises are competing in global markets that are increasingly complex and dynamic. A single enterprise may have a multitude of different departments, managers, and assignments, each having their own respective objectives, plans, and goals commensurate with their respective roles within the enterprise. Additionally, a single enterprise may have one or more enterprise-wide goals that involve the collaboration and involvement of its different departments, managers, and business units. For each goal, an enterprise may develop a plan for realizing the goal. A variety of tasks can be associated with realizing the goals in an organization. The tasks can facilitate incremental progress toward these goals and can involve potentially multiple different parties and departments within an organization. For instance, tasks can be assigned to various parties within the organization.

### BRIEF DESCRIPTION OF DRAWINGS

FIG. 1 is a simplified schematic diagram of an example computing system including a planning system;

FIG. 2 is a simplified block diagram of an example system including an example planning engine;

FIG. 3 is a simplified block diagram representing principles of a business model;

FIG. 4 is a simplified block diagram representing principles of hierarchical relationships defined in business models;

FIGS. 5A-5G are simplified block diagrams illustrating example features and models of example plan models;

FIG. 6A-6B are simplified block diagrams illustrating example relationships between business entities modeled in one or more example business models;

FIGS. 7A-7N are screenshots of example user interfaces for use in connection with an example planning system;

FIG. 8 are flowcharts of example techniques for task management through an example planning system.

Like reference numbers and designations in the various drawings indicate like elements.

### DETAILED DESCRIPTION

Modern enterprises can often include complex organizations, such as large multinational corporations with multiple business units and departments operating in multiple different countries, as well as organizations competing in multiple different marketplaces, including multiple product markets and geographical markets, among other examples. Organizations can also include stock and commodity markets and exchanges, non-profit organizations, charities, religious organization, educational institutions, joint-ventures, market segments, trade associations, and so on. Such organizations can adopt a variety of goals and plans in connection with their respective operation, including for-profit and not-for-profit goals. Planning and decision-making activities in connection with these goals has become increasingly complex. For instance, such goals can be set at various levels within the organization, including at the organization level (i.e., goals that apply to the entire organization) as well as at various sub-levels, such as the business unit sub-level, the department sub-level, the region sub-level, the office sub-level, etc. Further, separate goals or plans within an organization can be interrelated in that they involve similar business objects, products, or services, or rely on similar or interrelated metrics or other entities. Such business entities can include such entities as product categories, distribution channels, supply channels, customers, products, fiscal calendar terms, geographic regions and sub-regions, etc.

Tasks can be developed and assigned in furtherance of the goals of an organization. The tasks can include tasks that directly assist in realizing the goal, as well as tasks to correct course deviations from a plan. Additional tasks can also be generated that pertain to investigating and reporting on progress of a goal or plan, as well as the status of various assumptions upon which the plan and its progress rely, among other examples. The tasks can be associated with one or more business entities with which the plan is involved. Further, the tasks can be associated with corresponding business models modeling the business entities as well as the relationships between the business entities. Accordingly, relationships and dependencies between business entities can form the basis for propagating an association between a particular task and a particular business entity to the other business entities identified (e.g., in the business models) as related to the particular business entity.

Assigning and monitoring tasks can be a key challenge within an organization, such as a for profit company. Tasks can arise within the context of the business planning and business management processes of the organization. An integrated task management and planning system can be provided that can support task management, while retaining the explicit link between the business context of the task, and the task itself. This connection between the task and its business context can also assist the persons assigned the tasks. For instance, a challenge that is faced by employees in a company is that they often have little visibility into the business context of a task that is being assigned to them by management. An integrated task management system can provide employees with visibility into the context of their assigned tasks. For instance, an integrated task management and planning system can provide visibility to tasks' owners on each task's impact on the business plan, which can drive home the importance of the task to the organization and its broader objectives and thereby provide additional motivation to the employee, among other examples.

Planning activities can be modeled using software-based models to model the plans, goals, and outcomes within an organization. Such “plan models” (as well as other models) can be accessed and used by systems and users to assist in improving an organization's (or group of organizations′) planning activities, as well as the realization of the goals associated with their planning activities. A set of plan models can be provided, each plan model corresponding to a defined domain relevant to an organization and modeling aspects of that domain as well as the inputs and outcomes relevant to achieving or analyzing goals of the specified domain. Plan models can be used to enable interactive, quick, collaborative decision-making within an organization, including along particular user or department roles and functions. Additionally, plan models provide decision-makers of an organization with views into the business entities and attributes relevant to the organization's goals, including views at various levels of abstraction and detail. In general, such plan model and business scenarios can be used to guide the direction of real-world departments and business of an organization, whether for-profit or not-for-profit, to assist in the achieving of the organization's (or multiple organizations′) varied goals. In some instances, a plan model can incorporate principles and features described, for instance, in U.S. patent application Ser. No. 13/594,744, entitled “Distributed and Synchronized Network of Plan Models,” filed Aug. 24, 2012, incorporated herein by reference in its entirety.

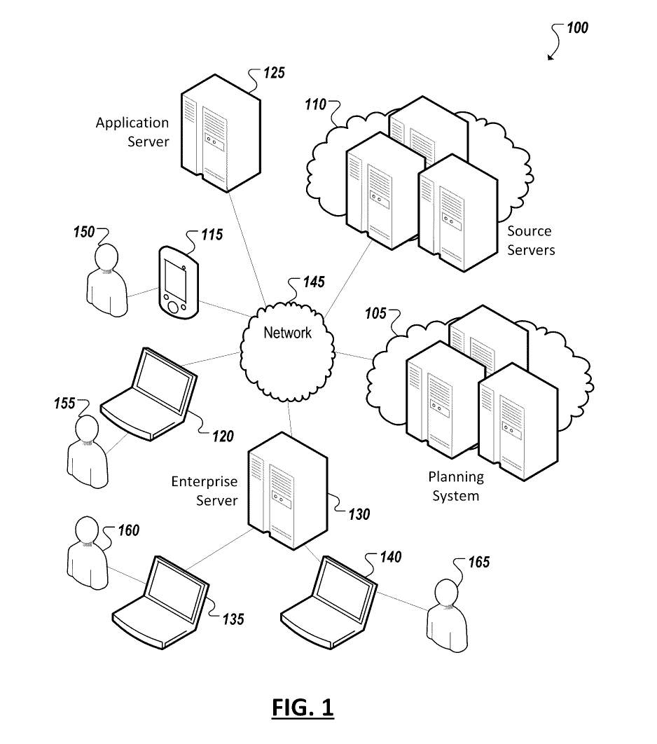

FIG. 1 is a simplified block diagram illustrating an example implementation of a computing system 100 including a planning system 105 capable of generating, maintaining, and serving a plurality of models to model aspects of an organization's business and further associate these models with tasks that are assigned within the organization. In some instances, the models themselves can model plans of the organization (e.g., plan models) and other models can model business entities affected by the plan. Tasks, too, can be directly related to the plan, but through the relationships and dependencies defined between models (and thereby business plans and entities) tasks can be cross-associated with other plans and business entities beyond what may have been originally intended or specified for the assigned task. Further, the universe of users interested in a task and its completion, such as domain owners responsible for a given business domain or plan, or employees to which a task is assigned, can be expanded by virtue of broadening the understanding of the way in which a single task potentially affects an organization and its intertwined business units, goals, products, etc., as modeled by the plurality of business models.

In some cases, business models, including user models, business entity models, plan models, and even task models, can be generated based upon source data from a variety of sources (e.g., both internal or external to an organization). For instance, source servers (e.g. 110) can include public and private online sources hosting information used in the models of planning system 105, including information to populate attributes and measures of model instances and provide information upon which assumptions, targets, and drivers defined in the models of the planning system 105 are based. Source data can further include unstructured data, including data from user collaborations relating to particular business entities or plans modeled by the planning system 105. Such collaborations can be used enrich the quality of the data and assumptions relied upon in these models. In some instances, collaboration tools and data can be integrated with business modeling and planning according to principles described in U.S. patent application Ser. No. 14/751,526, entitled “Plan Modeling and User Feedback”, filed Jun. 26, 2015, and incorporated by reference herein in its entirety.

In some implementations, a planning system 105 can further include programs, tools, and functionality allowing endpoint devices (e.g., 115, 120), such as user devices, to access and interact with models, including models described in U.S. patent application Ser. No. 13/594,744 and U.S. patent application Ser. No. 13/410,222, entitled “Global Market Modeling for Advanced Market Intelligence,” filed Mar. 1, 2012, incorporated herein by reference in its entirety. Users can interact with the models to edit, build, and interlink models, as well as build scenarios from the models, among other functionality and tools, including those discussed explicitly or implicitly herein. Endpoint user devices (e.g., 115, 120) that can include display devices and user interfaces allowing users (e.g., 150, 155, 160, 165) to interact with planning system 105, models hosted or provided through the planning system 105, and applications, programs, and services hosted or provided by the planning system that allow users to perform tasks involving the models, such as developing and comparing scenarios from the models, analyzing and generating working business plans for the organization from the models, generating tasks to be assigned to various users, completing said tasks, among other examples. In some instances, endpoint user devices can include endpoint devices planning system 105 allowing administrators, model developers, and other users to develop and maintain plan models and plan model tools hosted or provided by the planning system 105. Endpoint devices can also include computing devices remote from at least a portion of the planning system 105 and accessing planning system resources, such as model interaction tools and models, from the planning system 105 over one or more networks (e.g., 145). In some implementations all or a portion of the planning system 105 can be distributed to or implemented on endpoint devices (e.g., 115, 120, 135, 140), such as client-specific models, software tools for use by clients in interacting with and using models, etc.

In addition to endpoint devices, other systems can also act as clients of planning system 105. For instance, application servers (e.g., 125) hosting one or more applications, services, and other software-based resources can access and use plan models and functionality of planning system 105 in connection with the applications and services hosted by the application server (e.g., 125). Enterprise computing systems (e.g., 130) (e.g., including an enterprise resource planning (ERP) system)) can also interface with and use models and services provided through an example planning system 105. For instance, enterprise-specific plan models can be developed and used by endpoint devices (e.g., 145, 150) within the enterprise. In some instances, other enterprise tools and software can be provided through enterprise computing system 130 and consume data provided through plan models and plan-model-related services of the planning system 105, among other examples.

In general, “servers,” “clients,” and “computing devices,” including computing devices in example system 100 (e.g., 105, 110, 115, 120, 125, 130, 135, 140, etc.), can include electronic computing devices operable to receive, transmit, process, store, or manage data and information associated with computing system 100. As used in this document, the term “computer,” “computing device,” “processor,” or “processing device” is intended to encompass any suitable processing device. For example, the system 100 may be implemented using computers other than servers, including server pools. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, and computing devices (e.g., 105, 110, 115, 120, 125, 130, 135, 140, etc.) can each include one or more processors, computer-readable memory, and one or more interfaces, among other features and hardware. Servers can include any suitable software component or module, or computing device(s) capable of hosting and/or serving software applications and services (e.g., plan models and plan model applications and services of the planning system 105, applications and services of application server 125, applications and services of enterprise system 130, etc.), including distributed, enterprise, or cloud-based software applications, data, and services. For instance, servers can be configured to host, serve, or otherwise manage models and data structures, data sets, software service and applications interfacing, coordinating with, or dependent on or used by other services and devices. In some instances, a server, system, subsystem, or computing device can be implemented as some combination of devices that can be hosted on a common computing system, server, server pool, or cloud computing environment and share computing resources, including shared memory, processors, and interfaces.

User or endpoint computing devices (e.g., 115, 120, 135, 140, etc.) can include traditional and mobile computing devices, including personal computers, laptop computers, tablet computers, smartphones, personal digital assistants, feature phones, handheld video game consoles, desktop computers, internet-enabled televisions, and other devices designed to interface with human users and capable of communicating with other devices over one or more networks (e.g., 145). Attributes of user computing devices, and computing device generally, can vary widely from device to device, including the respective operating systems and collections of software programs loaded, installed, executed, operated, or otherwise accessible to each device. For instance, computing devices can run, execute, have installed, or otherwise include various sets of programs, including various combinations of operating systems, applications, plug-ins, applets, virtual machines, machine images, drivers, executable files, and other software-based programs capable of being run, executed, or otherwise used by the respective devices.

Some computing devices (e.g., 105, 110, 115, 120, 125, 130, 135, 140, etc.) can further include at least one graphical display device and user interfaces allowing a user to view and interact with graphical user interfaces of applications and other programs provided in system 100, including user interfaces and graphical representations of programs interacting with models and modeling tools and services provided, for example, by a planning system 105. Moreover, while user computing devices may be described in terms of being used by one user, this disclosure contemplates that many users may use one computer or that one user may use multiple computers.

While FIG. 1 is described as containing or being associated with a plurality of elements, not all elements illustrated within system 100 of FIG. 1 may be utilized in each alternative implementation of the present disclosure. Additionally, one or more of the elements described in connection with the examples of FIG. 1 may be located external to system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

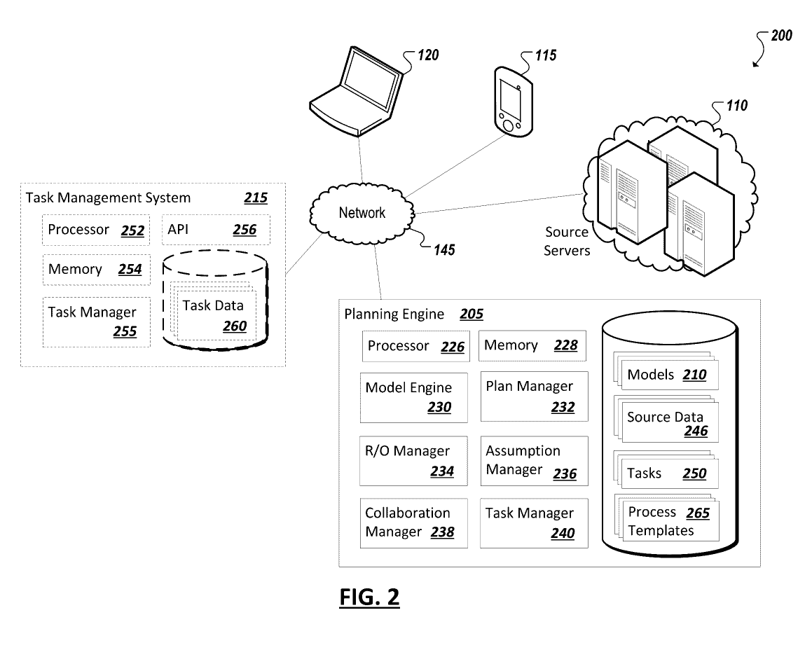

Turning to FIG. 2, a simplified block diagram 200 is shown of an example system including an example planning engine 205. In some instances, planning engine 205 can be hosted by a planning system, such as the planning system 105 described in the example of FIG. 1. In other examples, instances of a planning engine 205 (including multiple distinct instances) can be hosted on enterprise computing platforms and other computing environments accessing and otherwise making use of plan models (e.g., 210). A planning engine 205 can host, serve, maintain, access, or otherwise provide a set of models 210 used to model business entities, relationships between these entities, potential business outcomes of a particular organization or plurality of organizations, among other examples. A planning engine 205 can additionally include functionality for using, building, and editing these models 210. One or more systems (e.g., 215) can additionally be provided that include functionality for generating, assigning, tracking, and otherwise managing tasks of an organization. At least some of these tasks can be associated with business entities and plans modeled by business models 210 of the planning engine 205, allowing the information defined in the models to supplement the tasks and guide users assigned to or managing the tasks. Moreover, the example system 200 of FIG. 2 can further include one or more additional computing devices, systems, and software-based tools (e.g., 115, 120, 130, 215, etc.) communicating with plan model engine 205, for instance, over one or more networks (e.g., 145).

In one example implementation, a planning engine 205 can include one or more processors (e.g., 226) and memory elements (e.g., 228), as well as one or more software- and/or hardware-implemented components and tools embodying functionality of the planning engine 205. In some examples, a planning engine 205 can include such components and functionality as a model engine 230, plan manger 232, risk and opportunity (R/O) manager 234, assumption manager 236, collaboration manager 238, and task manager 240, among potentially other additional or alternative components, modules, and functionality, including combinations of functionality and tools described herein. In addition, in some implementations, a planning engine can include models 210 either hosted local to the planning engine 205 and/or accessed from other remote model servers or other data stores. Functionality of planning engine 205 can access, utilize, and consume models generated through or in connection with the planning engine 205 as well as potentially models of other business modeling systems (e.g., another instance of a planning system and engine belonging to another enterprise distinct from the enterprise or host of planning engine 205), among other examples.

In some implementations, an example model engine 230 can include functionality for identifying and accessing models 210, including plan models and models modeling entities within an organization including products, services, departments, and business units within the organization, among other examples. In some implementations, a model engine can also identify instances where a plan model is to be generated, edited, or otherwise modified (e.g., in connection with a task performed referencing or otherwise associated with the mode). An example model engine 230 can further include functionality for creating or editing business models. As an example, a plan model can be generated by instantiating an instance of a preexisting plan model, plan model template (or class), among other examples. Further, in some implementations, user interfaces and controls can be provided in connection with an example model engine 230 allowing human or automated users to input data to populate attributes of various model instances. In some instances, source data (e.g., 246) can also be collected, requested, retrieved, or otherwise accessed to populate attribute fields, build logic of the plan model, and be otherwise used (e.g., by model engine 230) to generate an instantiation of a particular model for addition to the set of plan models 210.

In some cases, models used and generated by planning engine 205 (e.g., through model engine 230), can include models of entities, assumptions, processes, and scenarios relating to a plan of an organization. Such “plan models” can be defined by an organization as a model of a current working plan, goal, assumption, or approach to be considered by the organization both in its analysis of other business scenarios as well as drive the real world behavior and decision-making of the organization. Various versions of one or more plan models (or other models that relate to or support the modeling of an organization's plan(s)) can be tracked and managed using an example plan manager 232. For instance, a plan manager 232 can manage status of plan models, including modeled scenarios generated based on plan models. For example, a particular modeled scenario can be designated as a current working model, adopted business plan, etc. of an organization, and serve as a guide to the organization's decision makers and employees and define particular thresholds, activities, and progress that are to be achieved or pursued in the furtherance of the associated plan or goal. The plan manager 232 can further include functionality for generating hypothetical business scenarios based on one or more plan models. Such scenarios can include modeled scenarios based on particular or varying input drivers (e.g., modeling real world business-related inputs affecting a particular business goal or outcome), as well as based on particular goals (e.g., modeling hypothetical conditions that could result in a particular outcome). Additionally, some implementations of plan manager 232 can further include functionality adapted to provide guidance to users in connection with the generation or modification of a particular scenario or comparisons of generated scenarios. Further, implementations of a plan manager 232 can additionally include functionality for comparing generated scenarios, for instance, to determine whether a particular scenario is superior to another (e.g., in connection with determining a working plan for the organization), among other examples.

As noted above, in some instances, a particular plan model in a set of plan models can model business outcomes relating to a particular business unit, department, domain, or sub-organization of an organization. Accordingly, some plan models may better relate to or be understandable to particular subsets of users and decision-makers within an organization. These users can also be provided with visibility into the tasks that have been assigned and associated with the corresponding plan models, including the progress of these tasks. Indeed, one or more plan models can be provided and associated with each department, business unit, etc. of an organization having associated plan models in the network relevant to the particular entities, outcomes, work, and goals of that sub-organization. With each sub-organization utilizing, controlling, and accessing its own related plan models, collaborative decision-making and scenario-planning can be accomplished across an organization as the network of plan models models interplay and interconnectedness of various goals and outcomes of the various sub-organizations, as well as the interrelatedness of various tasks (e.g., based on the defined relationships between associated plan models and business entity models). Indeed, in some implementations, interactions with some models, including plan models, can be at least partially restricted, limited, or otherwise organized to provide varying levels of access to the models based on a user's respective association with, ownership, or expertise in the sub-organization, product, business, unit, etc. to which the particular models are related. In connection with this, models can be defined and used to define such aspects as users' roles, identities, and attributes as well as the users' respective permissions, access, and associations to one or more respective models, among other examples.

While information can be obtained from more structured or organized sources, such as websites, online articles, databases, and other sources of market or organization information, organizations themselves generate large amounts of data through digital communications and collaborations within the organization (or to and from the organization and third party customers, vendors, partners, etc.). In some implementations, a collaboration manager 238 can be provided that can mine unstructured data, such as data generated from discussion and collaboration tools, including instant messaging, discussion board, email, social media, and other collaboration platforms used either or both by persons within a corresponding organization or persons outside the organization. This collaboration data, along with other source data 246, can be acquired by, sent to, or otherwise accessed by the planning engine 205 and the discussions and collaborations identified and defined by the data can be determined to relate to entities and/or plans modeled in models 210. Further, in some implementations, tasks can be assigned in connection with these discussions and collaborations. The tasks can thereby be associated with the corresponding discussions and collaborations as well as the entities and plans of models 210 identified as associated with the discussions and collaborations. Indeed, as models 210 can themselves define dependencies and relationships between entities, between plans, between entities and plans, etc., associations identified in discussion data can be extended based on the relationships defined in models 210. Associations between collaboration data and models can be determined automatically, for instance, using logic of collaboration manager 238, as well as (or alternatively) through user feedback received through one or more graphical user interfaces of planning engine 205 or a corresponding collaboration tools, allowing a user to manually associate a discussion with one or more plans or business entities, among other examples. Indeed, such interfaces can include controls for defining and assigning one or more related tasks, causing such tasks to be associated with the corresponding models (e.g., 210).

Additional tasks and actions can be performed on discussions identified (e.g., by collaboration manager 238) as associated with a given business entity or plan. For instance, user feedback can be received to identify at least a portion of a discussion as evidence of a risk or opportunity associated with the related business entity or plan. A risk can be an event, circumstance, trend, or condition that suggests that a business entity or plan (e.g., modeled in models 210) will be affected negatively. An opportunity, on the other hand, can be an event, circumstance, trend, or condition that suggests that a business entity or plan is likely to be affected or impacted positively. Users, appreciating the implication of a condition, fact, event, etc. expressed in a particular portion of a discussion, can tag that portion of the discussion as representing a risk or opportunity. The risk or opportunity can then be associated with any plans or business entities identified as associated with the discussion. An R/O manager 234 can be provided to implement this functionality, including defining associations between risks and opportunities and modeled entities and plans, as well as supporting user interfaces receiving user inputs indicating whether a discussion is evidence of a risk or opportunity, among other related functionality.

A discussion, or part of a discussion, can also serve as evidence of the accuracy (or inaccuracy) of an assumption (e.g., a particular attribute value, formula, relationship, etc.) upon which one or more models (e.g., in 210) depend. For instance, the content of a user entry in a discussion can indicate that an assumption over- or under-estimates a condition or effect, or alternatively indicate that an assumption is on target. Assumptions can be tracked and adjusted where appropriate. An assumption manager 236 can be provided in some implementations to allow authorized users to track the historical accuracy of assumptions in one or more models 210. The basis for determining that an assumption is accurate or not can be established through empirical data from sources (e.g., 130), such as empirical data that indicate the true value realized for a particular measure. The basis of an assumption's accuracy can also be based on information expressed by users in collaboration data or other source data 246. Assessing the accuracy of an assumption can be done retrospectively (e.g., after the actual value or relationship has been observed for comparison with the corresponding assumption used in the model) or prospectively (e.g., based on information that indicates that the assumption is likely to end up being accurate/inaccurate). Further, as prospective feedback is received regarding the accuracy of an assumption, an owner of the model(s) relying on the assumption can be notified (e.g., using planning engine 205 logic) to allow the owners to assess the effect of the feedback on the model, as well as plans defined by the model. In some cases, a user can adjust an assumption to account for new information obtained from feedback received (e.g., in discussion data) indicating that the assumption is not entirely accurate.

Risk and opportunity identifications, as well as assumption feedback, can motivate action within an organization to address this new intelligence. Indeed, tasks can be assigned that correspond to an indicated risk or opportunity or assumption accuracy feedback. Further, launching or assigning a task associated with a risk/opportunity or assumption can cause associations between the risk/opportunity or assumption and one or more models 210 (and associated business entities and/or plans) to propagate to the corresponding tasks (e.g., 250). In some implementations, tasks 250 related to plans and business entities modeled in models 210 can be defined and managed using a task manager 240 of planning engine 205. In some cases, functionality can be provided to assign tasks based on user feedback or discussions received in connection with planning engine, including associated discussion data identified by collaboration manager 238, risk and opportunity indications defined using R/O manager 234, and assumption feedback received through assumption manger 236, among other potential e examples. For instance, a task can be assigned based on a risk or opportunity identified by a user or in response to an indication that a particular assumption is inaccurate. Such tasks can relate to investigating and/or addressing the issues related to the respective indication. Additionally, such user feedback and discussion data can be associated with an existing task or with a new task during the definition of the task, to assist the users assigned to perform and supervise the task with additional context and intelligence relating to the assigned task. The task manager 240 can provide further functionality, including monitoring and tracking progress of a task, task assignments, and other functions related to the creation, assignment, and management of tasks relating to business and planning and associated models 210, among other examples.

As noted, in some implementations, tasks 250 can be generated using logic of a planning system (e.g., task manager 240). In some instances, tasks and task data generated by other systems (e.g., 255) can also be integrated with a planning system such that their tasks are associated with one or more business models 210 of the planning engine 205 are associated with the tasks. For instance, a task management system 215 platform or service can be provided that can operate or be deployed independent of planning engine 205. A task management system 215 can include, for instance, one or more processors 252, one or more memory elements 254, and one or more logical components implemented in hardware and/or software, such as task manager 255. The task manager 255 of task management system 215 can include functionality for creating, assigning, monitoring, and closing tasks for one or more organization. Corresponding task data 260 can be generated by the task manager 255 to describe the tasks. Planning engine 205, in some implementations, can remotely access or otherwise obtain the task data 260 of a remote or independent task management system 215, such as through an application programming interface (API) 256 of the task management system 215, among other examples. The planning engine 205 can include logic (e.g., through task manager 240) to identify associations between task data 260 and models 210, such as by identifying references within task data 260 to business entities (or business entity attributes) modeled by the models 210, identifying user tags associating task data with one or more business entities or plans, among other examples.

In some implementations, a task manager 240 implemented in connection with a planning engine 205 and a task manager 255 implemented separate from the planning engine 205 can possess similar functionality, allowing users to create, assign, edit, monitor, and otherwise manage tasks. The planning engine 205 can build associations between either tasks 250 or task data 260 to allow relationships to be defined between the corresponding tasks and one or more models 210. Tasks can also be generated or assigned in connection with the viewing of a model or another model-related activity. In some cases, a task can be an instance of a pre-defined type of task. In other cases, a customized task can be created ad hoc for a particular purpose. In some implementations, larger projects or processes can be defined with multiple steps or checkpoints. These steps or checkpoints can each have one or more associated tasks. Accordingly, a project or process can include multiple component tasks that are to be completed before the project or process can be considered complete. Indeed, in some implementations, a process template 265 can be defined for each process (or project) that defines the set (and potentially order) of steps within a given process. A process, itself, can be defined for a specific business unit, plan, or business entity. Further, tasks can be automatically generated and assigned based on the creation of an instance of a defined process instance, among other example features.

Other components of or operable with a planning engine 205 can include discussion features to allow users to comment are various aspects of plans and business entities modeled by business models 210. For instance, a discussion system can be provided, such as a private or public social network platform, instant messaging platform, discussion board platform, or other platform or tool facilitating discussion and/or collaboration between users, can generate discussion data describing the communications of users utilizing the discussion system. Users can participate in discussions and collaboration provided by discussion system utilizing various endpoint devices (e.g., 115, 120, etc.). Users can generate discussion posts and other discussion and collaboration data, as well as view the discussion posts generated by others utilizing endpoint devices (e.g., 115, 120). In some cases, functionality can be further provided to support tagging and feedback of discussion posts and other discussion data by users in connection with the features of a planning system, including risk and opportunity tagging, associating discussions with models, providing assumptions feedback, among other examples. Associations can be automatically identified between this discussion data and models 210 and information included in the discussion data can be used to supplement and improve information included in the models 210.

User inputs received from user endpoints in connection with discussions hosted by a discussion system can be described in discussion data. Other discussion or collaboration data (collectively discussion data) can be collected by other systems, such as email servers, discussion board servers, etc., and planning system can access discussion data from potentially multiple different sources. For instance, the collaboration manager 238 can access discussion data from various sources (e.g., 110) and identify portions of the discussion data that correspond to plans and/or business entities modeled by models 210.

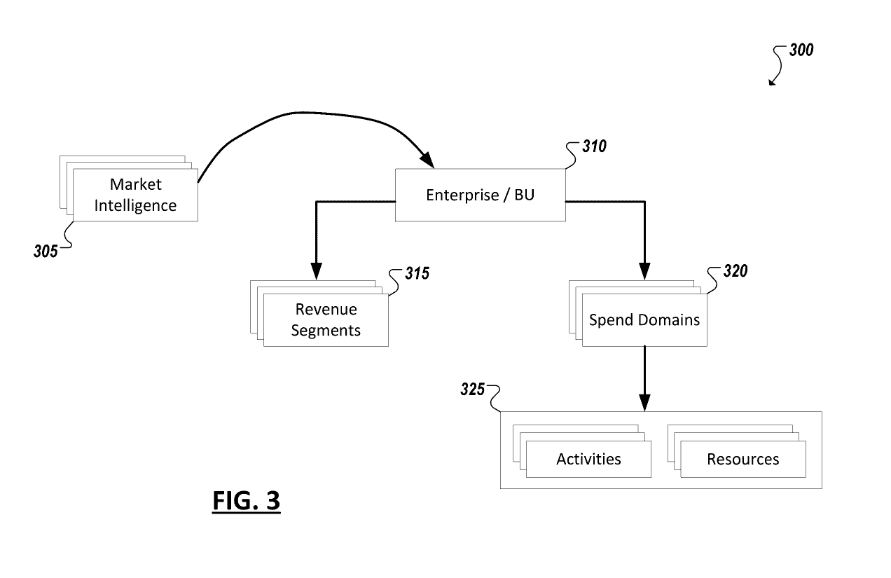

Turning to the example of FIG. 3, a simplified representation 300 is shown representing principles of an example modeling approach (such as implemented in models 210). An enterprise can be modeled using dimensional and activity network constructs. For instance, such constructs can be derived from an industry reference model that forms the basis of modeling any enterprise within the industry. The reference model shown in FIG. 3 includes some of the basic entities that reflect some of the key plans and models to depict an enterprise. For instance, market intelligence 305 (collected from one or more sources) can be used to develop a model of an enterprise 310, which further models the various revenue segments 315 pursued by the enterprise (or business unit) and the spend domains 320 of the enterprise. Models of these revenue segments and/or spend domains can include additional sub-models (e.g., 325), such as models of activities and resources within each spend domain, among other examples. The various plans and models (e.g., of a model of enterprise 310) can be linked through measures and relationships. The relationships between the various plan entities can include relationships that are hierarchical in nature modeled using dimensional constructs or relationships that are relational and modeled using either association matrix constructs or graph network representations, among other examples. The models can incorporate both these types so that relationships include both hierarchical and related concepts. This translates to a rich metadata representation within the application that understands and maintains relationships for the various elements including ancestors (parent relationships), descendants (children relationships), siblings, related, associated, etc. Meta-models can be further maintained to define these relationships, including dimensional and graph meta-models (e.g., (dimensions, hierarchies, attributes, network, relationships etc.)

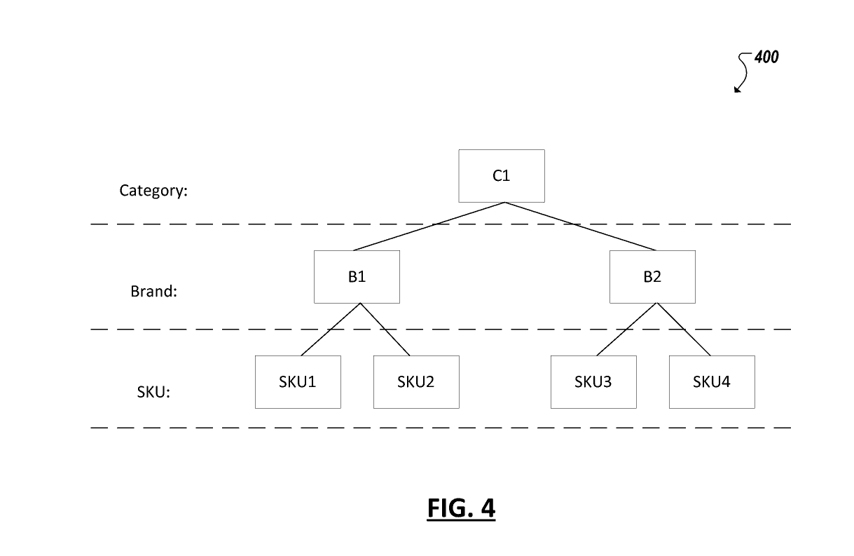

FIG. 4 is a simplified representation 400 of hierarchical relationships defined for an example product dimension, such as can be defined in corresponding meta-models of a planning system. For instance, the example product dimension can be hierarchical in nature, with each product/service category (e.g., C1) having corresponding brands (e.g., B1, B2) under the category. The brands can have individual products (or services) under the brand within the hierarchy, such as SKU1 and SKU2 under brand B1, etc.

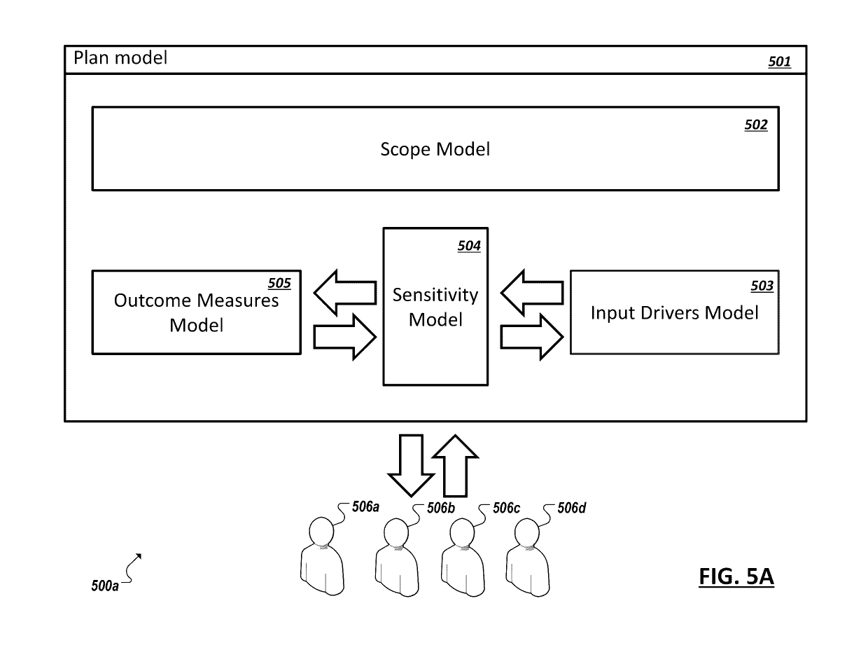

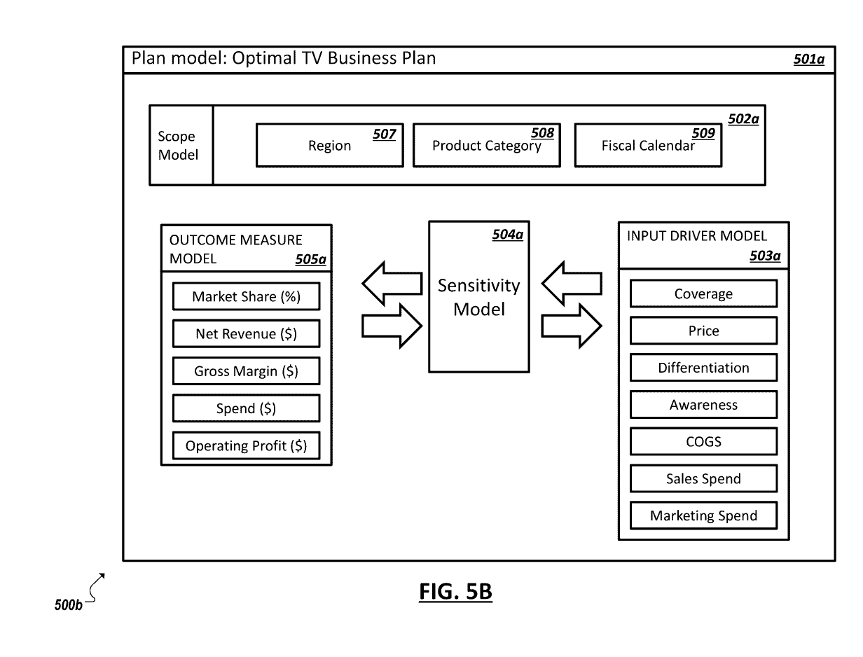

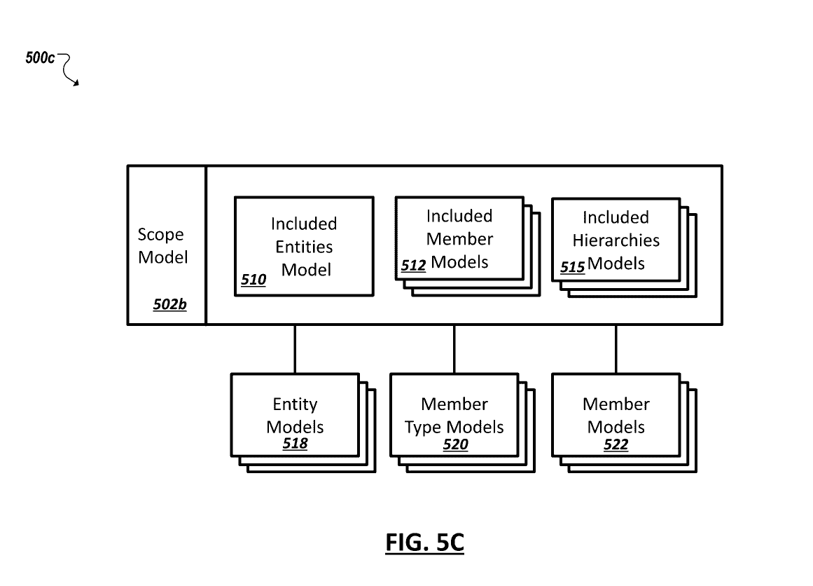

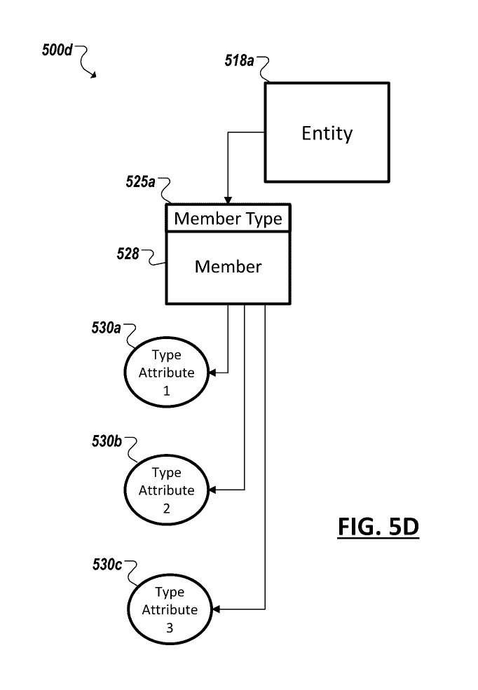

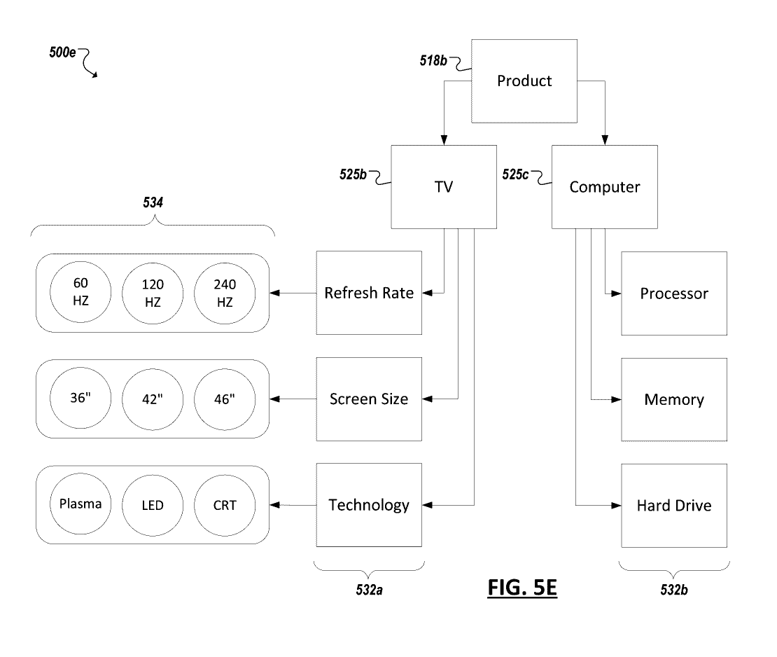

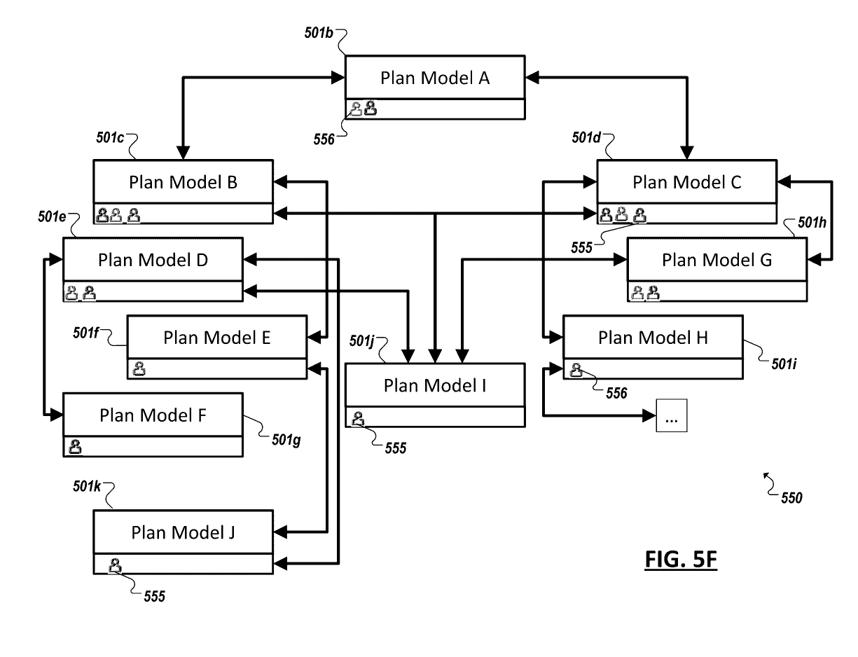

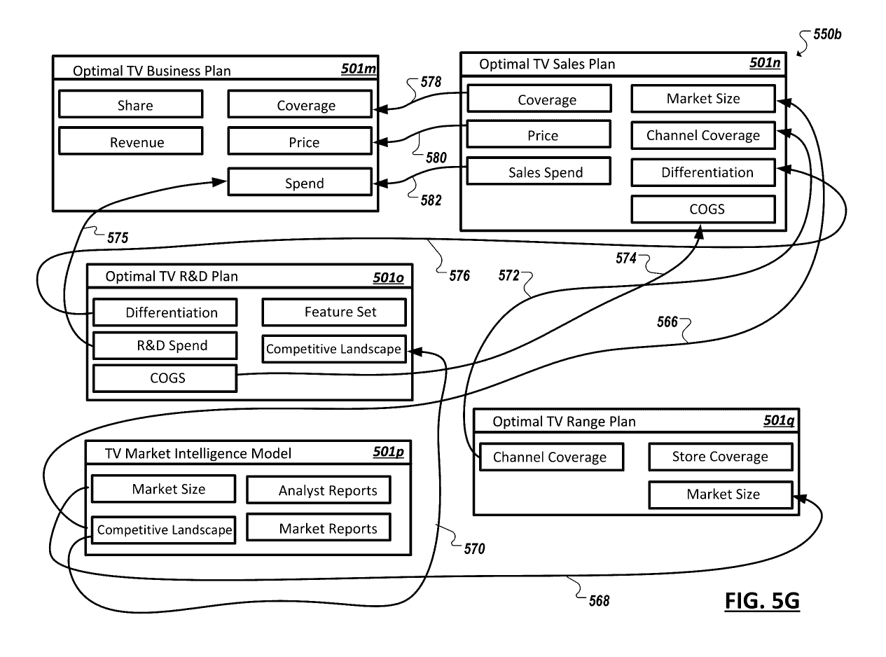

FIG. 5A shows a simplified representation 500a of an example software-implemented plan model 501, in accordance with some implementations. A plurality of instances of plan model 501 can be developed, each instance of plan model 501 modeling a respective business outcome of an organization (or group of organizations), including business outcomes relating to administrative, educational, charity, commercial, industrial, logistic, and other for profit and not-for-profit activities of the organization. In one example implementation, a plan model can include a scope model 502, an input drivers model 503, a sensitivity model 504, and outcome measures model 505. Additional models can be included in or linked to by a respective plan model, such as entity models, member models, and hierarchy models, among other examples. Additionally, in some implementations, plan models can each include a process model for use in managing planning activities involving the plan model as well as coordinating planning activities between multiple plan models. Further, one or more designated users, user roles, or users within particular sub-organization (collectively users 506a-d) can interact with and use the plan model, for instance, in connection with planning activities within one or more organizations, among other examples.

A scope model 502 can identify and model the specific domain within an organization on which the particular instance of the plan model 501 operates and is associated with. Domains can be relatively broad or narrow and capture certain segments of a particular organization. The scope model 502 can further enable certain domain-specific planning processes and logic relevant to the corresponding domain within the organization. Input drivers model 503 can represent one or more input drivers specifying key variables influencing outcome measures modeled by the particular domain-specific instance of the plan model 501. Accordingly, outcome measures model 505 can model and represent the outcome measures that the particular instance of the plan model will state, predict or attempt to achieve in its modeling of a particular business outcome(s) which can also be expressed as one or more of the outcome measures modeled in outcome measures model 505. A sensitivity model 504 can define the dependencies, relationships, processes, formulas, and other logic used to derive values of various outcome measures from values of input drivers of the plan model 501. Such dependencies, relationships, processes, formulas, and other logic (collectively dependencies) can be domain-specific as well as define how values of intermediate outcome measures or input drivers can be derived from other input drivers or outcome measure values, among other examples.

Turning to the example of FIG. 5B, a simplified schematic block diagram 500b is shown of a particular example instance of a plan model 501a. In this example, the plan model 501a is an optimal television business plan model modeling outcomes for a particular product category of a business (e.g., a business selling televisions). As in the example of FIG. 5A, example plan model instance 501a can include a scope model 502a, input drivers model 503a, sensitivity model 504a, and outcome measures model 505a. Scope model 502a defines a domain to which the modeled outcomes of plan model 501a apply. For instance, scope model 502a can model a domain encompassing a particular product category (i.e., TVs), within one or more geographic regions (or market regions), and within a particular period of time (e.g., a fiscal quarter, year, five year span, etc.). Accordingly, scope model 502a can define the domain according to one or more business entities, such as regions, product categories, and fiscal calendar, among other examples. Moreover, in this implementation, scope model 502a can include entity models 507, 508, 509 corresponding to the relevant business entities used to define the domain in the scope model 502a (e.g., geographic region, product category, fiscal calendar period, etc.).

A plan model's domain, as defined in its scope model (e.g., 502) can drive other models (e.g., 503, 504, 505) of the plan model as the inputs, outcomes, and relationships between outcomes and inputs (e.g., as defined in sensitivity model 504) can be highly domain-specific and tied back to the particular business entities used to define the modeled domain. For instance, in the example input drivers model 503 can include such input drivers, or variables, pertaining to a television product category and product market region for televisions, including input drivers such as channel coverage, price, product differentiation, consumer awareness, cost of goods sold (COGS) or inventory cost, sales spend, marketing spend, etc. Similarly, outcome measures relevant to the outcome, or goal, modeled for the defined domain can be defined in outcome measures model 505, such as market share percentage, net revenue, gross margin, total spend, operating profit, etc.

It should be appreciated that FIG. 5B is but one illustrative example, and that plan models can model a potentially limitless variety of plans. Accordingly, plan models can model outcomes of corresponding domains that result in sets of input drivers and outcome measures quite different from the input drivers and outcome measures of the particular example of FIG. 5B. However, other plan models can also be developed for different domains (e.g., a different market region, different product, products of a different organization, etc.) that include input drivers and outcome measures similar to those of the optimal television business plan model 501b. The dependencies of the respective outcome measures on the respective input measures of a particular domain, however, can fluctuate considerably between domains. For instance, sensitivity of a market share outcome measure to particular input drivers such as price or product differentiation can be quite different in two different markets, including different product markets and market regions. Accordingly, sensitivity model 504 can define domain-specific dependencies between input drivers and outcome measures for a plan model of a particular domain, representing the sensitivities of the outcome measures to the respective input drivers upon which the value of the outcome measure is dependent.

Turning to FIG. 5C, a simplified block diagram 500c is shown illustrating an example scope model structure. For instance, instances of a scope model 502b included in plan models can include an included entities model 510, one or more included members models 512, and one or more included hierarchies models 515 corresponding to those business entities designated as defining the particular domain of the scope model instance 502b. The included entities model 510 and included member models 512 can reference or link to one or more entity models 518, member type models 520, and member models 522 maintained in connection with a plan model system. As noted above and in other example discussed herein, business entities can include such entities as regions, organizations, persons, products, product categories, market regions, market segments, channels, calendar periods, time, locations, customers, suppliers, factories, and so on. The entities included in the domain can be defined in included entities model 510. A particular business entity can have constituent subcategories of business entities, or member types, and particular members of these entity member types can be included in the particular domain to which a plan model applies. Accordingly, in some examples, each entity designated in included entities model can have a corresponding set of designated members of the respective entity designated in a respective included member model 512. Additionally, for each designated entity, a set of included hierarchies (or included different possible hierarchical representations of the included members of an entity) can be designated in included hierarchies models 515, each entity having its own included hierarchy model 515. In other implementations, the sets of included members and/or included hierarchies can be defined in a single included member model for the scope model 502b or a single included hierarchies model for the scope model 502b (i.e., rather than distinct included member models 512 and included hierarchies models 515 for each individual entity designated in an included entities model 510), among other examples.

Further, a scope model 502b can reference (e.g., through included entities model 510) corresponding entity models 518 of the designated included entities of the domain modeled by the scope model. Entity models 518 can model a particular entity as well as the member types of the entity, hierarchies of the entity, and other attributes and information pertaining to the individual entity. Member type models 520 can also be referenced through the scope model, each member type model 520 modeling a particular type of the business entity as well as defining relevant attributes of that member type (or member type attributes). Further, member models 522 can be referenced, corresponding to the included member models 512, each member model 522 defining the individual members within a particular modeled domain. Each member can be of a particular one of the member type models 520. In some implementations, included member models 512 can be defined for each entity of the domain and included as sub-models of the entity models 518. Relationships between entities, member types, members (or groups (or “sets”) of members), and particular member type attributes can be hierarchical and, in some instances, be organized in multi-dimensional hierarchies that allow members, member groups, and member type attributes to organized in multiple different alternate hierarchies. Such hierarchical organizations can be defined, in some instances, through included hierarchies models 515.

Turning to FIG. 5D, an example block diagram 500b is shown of a simplified hierarchy of a business entity as can be captured through one or more models of the corresponding scope model and/or entity model of a corresponding included business entity including corresponding member type models, member models, included hierarchies models, etc. For instance, in the particular example of FIG. 5D, a member type can be one of a plurality of member types of an entity and each member type (e.g., 525a) can include one or more instances, or members (e.g., 528), of that particular member type (e.g., 525a). The member type (e.g., 525a) can define a set of member type attributes (e.g., 530a-c) relevant to members of that type and that can define members of that type. Indeed, each member (and member model) of a particular member type can inherit the member type attributes of the corresponding member type. To illustrate, turning to FIG. 5E, an example entity 518b is illustrated corresponding to a product business entity. Within the global marketplace a wide variety of different products may exist from smartphones, printers, and digital video recorders to cardboard packaging, breakfast cereal, and tissue papers, among scores of other examples. Further, in the example of product business entities, various products may have relevance to different organizations and different goals within the same organization. Accordingly, plan models can include product business entities within their domains for different reasons in modeling particular outcomes, including domains corresponding to particular products of a particular business unit of an organization, corresponding to competitor products, corresponding to marketing budgets, inventory, etc.

In the particular example 500e of FIG. 5E, a scope model can define a particular domain to which a particular plan model applies by defining two particular member types within the product business entity 518b, in this example, a televisions member type (525b) and computer member type (525c). Each of the member types 525b, 525c can respectively define a set of member-type attributes (e.g., 532a, 532b) describing features and details generally relevant to members of that type. For example, a television member type 525b can include member type attributes such as the refresh rate, screen size, and technology (e.g., LED, LCD, plasma, etc.) of a particular television (i.e., member of the television member type), including other potential television-related attributes. Similarly, a computer member type, while a member type of the same business entity (e.g., Product), can have a different set of attributes corresponding to features and specifications of computers, such as processor type, processor speed, memory, hard drive, etc.

Each member of a member type can be defined, at least in part, according to attribute values defined for the member. For instance, a variety of different attribute values (e.g., 534) may exist among a set of members. For example, a first television member considered in the domain may be a 120 Hz 42″ LCD television, while a second television member in the domain is a 240 Hz 46″ plasma model. In some instances, multiple members in a member type can share one or more attribute values. Shared member type attributes can serve as the basis for member groups. For instance, a group of members of the example television member type of FIG. 5C can be defined based on screen size, with a group of televisions being defined for 36″ televisions, 42″ televisions, 46″ televisions, and so on.

Turning to the example of FIG. 5F, a simplified block diagram is shown representing a network 550a of plan models (e.g., 501b, 501c, 501d, 501e, 5011, 501g, 501h, 501i, 501j, 501k). Plan models in the network 550 can be interconnected with one or more different other plan models in the network 550 based on one or more input drivers of the plan model being dependent on one or more outcome measures (or even input drivers) of another plan model in the network 550. Further, a plan model in the network 550 can also be interconnected with other plan models in the network 550 by virtue of an outcome measure (or input driver) of the plan model driving values of input drivers of the other plan model. Each plan model in the network 550 with respective included scope models, input drivers models, outcome measures models, sensitivity models, process models, etc. The respective models of each plan model in the network 550 can be tailored to model outcomes for a particular, distinct domain within the network, including representative scope models, sets of input drivers and outcome measures, etc.

Further, different users (or groups of users) (e.g., 555, 556) within an organization (or organizations) of the network 550 of plan models can be assigned to or associated with particular plan models in the network 550. Such associations can be based, for instance, on the users' respective roles, office locations, departments, etc. within the organization, with particular plan models being made available to those users corresponding to the particular defined domain of the respective plan model. As a simplified example, a particular user can be a manager of a particular department of an organization that is responsible for one or more different product lines. As the particular user 1118 can be responsible for managing, planning, and making decisions within this particular realm of the organization, the particular user 555 can be associated with plan models that relate to the user's role, such as plan models (e.g., 501d, 501j, 501k) with domains corresponding to the particular department or constituent product lines of the user. Being associated with the plan models can authorize access and use of the respective plan models 501d, 501j, 501k associated with the user in some instances. Other users not associated with the plan models 501d, 501j, 501k may be blocked or limited in their ability to access and use the plan model 501d, 501j, 501k. However, other users (e.g., 556) can be associated with other plan models (e.g., 501i) with domains more pertinent to their role within an organization. Some users can be associated with multiple plan models based on their role(s) within the organization, among other examples.

Dependencies between values of outcome measures (or other input drivers) of one plan model and input drivers (or outcome measures) of another plan model can be defined through link expressions. FIG. 5G illustrates one potential example of link expressions (e.g., 566, 568, 570, 572, 574, 576, 578, 580, 582) between example plan models (e.g., 501m, 501n, 501o, 501p, 501q) in a network 550b of plan models. In the example of FIG. 11B, input drivers of each of the represented plan models 501m, 501n, 501o, 501p, 501q are listed in a right column and outcome measures in a left column. For instance, example Optimal TV Business Plan plan model 584 can include input drivers Coverage, Price, and Spend while including outcome measures Share and Revenue. As further illustrated by FIG. 5G, inputs drivers of the example Optimal TV Business Plan plan model 501m can be based on outcome measures of other plan models. For instance, values of Coverage input driver of example Optimal TV Business Plan plan model 584 can be dependent on a Coverage outcome measure of example Optimal TV Sales Plan plan model 585, the dependency defined through a link expression 578. Similarly, the Price input driver of plan model 584 can be dependent on a Price outcome measure of plan model 585 and the Spend input driver of plan model 501m can be dependent on multiple outcome measures (Sales Spend and R&D Spend) of two different plan models (e.g., 501n, 501o), with respective link expressions (e.g., 582, 575) defining the dependencies between the respective input drivers and outcome measures, among other examples.

Link expressions (e.g., 566, 568, 570, 572, 574, 576, 578, 580, 582) can interconnect example plan models (e.g., 501m, 501n, 501o, 501p, 501q) in a network 550b of plan models and further enable scenario planning, analyses, and other uses across multiple plan models. An association between a one or more tasks and a particular one of the plan models can be extended to cause the tasks to be associated with one or more other plan models based on the link expressions. Such links can also enable users of the network of plan models to cross-collaborate and plan across multiple, corresponding domains within an organization. This can also facilitate propagation of user-provided feedback regarding a model and its modeled entities, including discussions or collaborations identified as associated with the entities, risks or opportunities identified for plans, user feedback of assumptions of the plan models, among other examples.

As noted above, tasks can be generated and associated with one or more business models, based on the task's relationship to a plan, domain, or other business entity modeled by the business model. The association can be made based tags or other content of the task that is identified (e.g., by planning system logic) as pertaining to one or more business entities modeled by one or more business models. In other instances, a task can be generated in connection with a view of one or more business models and can be associated with these business models based upon the context of the task's generation. Further, while some associations between a task and a particular business model can be explicit (as identified automatically by planning system logic or manually by a user), the task can be further associated with additional business models based on relationships defined between the particular business model and the other business models (such as the relationships and links between models discussed above).

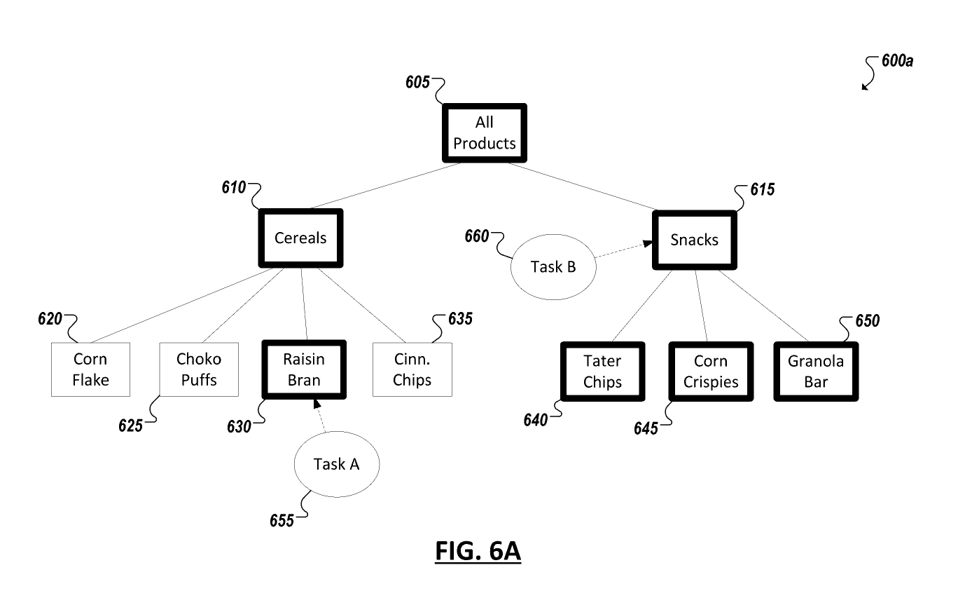

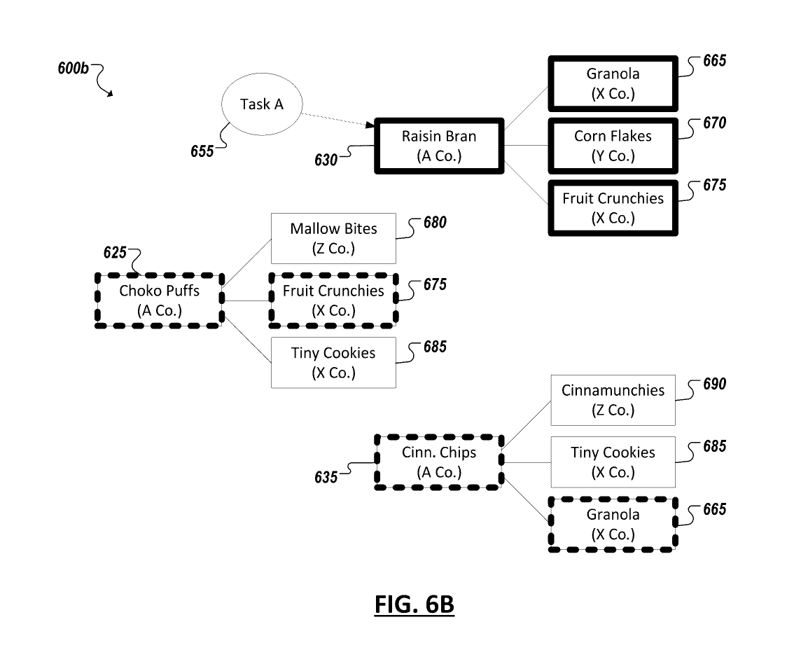

As an example, FIGS. 6A and 6B show diagrams 600a-b illustrating example relationships between business entities that can be defined in one or more business models (including within and between plan models). These relationships can also extend to corresponding business models, resulting in a link, dependency, or other association between the business models. In the example of FIG. 6A, a hierarchical relationship is shown of a business entity 605 corresponding to all products currently offered by a particular company (e.g., Company A). A hierarchical relationship can exist between the All Products entity 605 and two groupings of the products embodied as a Cereals member type 610 and a Snack member type 615. For instance, the products of the company can be divided into two product categories: cereal and snacks. Within the cereal product category 610 the company can offer a Corn Flakes product 620, a Choko Puffs product 625, a Raisin Bran product 630, and a Cinnamon Chips product 635. The products 620, 625, 630, 635 can be hierarchically related to the product category 610 in that each product is a child of a single parent product category. Similarly, products 640, 645, 650 can be defined to be hierarchically related to the Snack product category 615.

Continuing with the example of FIG. 6A, a variety of tasks can be assigned relating to planning for a particular domain. The task can particularly relate to a respective business entity, such as a product member or product category, as examples. For instance, in the example of FIG. 6A, a task 655 (“Task A”) can be determined to be related to the Raisin Bran product 630 and can thereby be associated with corresponding business models. Relationships can be identified between the product 630 and other business entities (e.g., the cereal product category 610 and the products 605 of Company A) such that identifying or determining that the task 655 is associated with product 630 automatically causes the task 655 to be associated with those entities (e.g., 605, 610) with which the entity (e.g., 630) as a hierarchical parent or child relationship. In another example, a second task 660 (“Task B”) can be determined to pertain to a Snacks product category entity 615 and can be associated with corresponding business models. Further, based on the relationships defined between the Snacks product category 615 and its parent (e.g., 605) and children (e.g., 640, 645, 650) business entities, the association between Task B 660 and the Snacks product category 615 can be propagated to also associate task 660 with these other business entities (e.g., 605, 640, 645, 650) and associated business models (including associated plan models).

Non-hierarchical relationships can also be defined in business models between various business entities. For instance, in the example of FIG. 6B, non-hierarchical relationships can include, as but one example, competitors of a product or company, where multiple products, brands, or companies can share at least some of the same competitors, among other examples of non-hierarchical relationships. FIG. 6B illustrates example competitive relationships that can be modeled by business models of a planning system. For instance, in the particular example of FIG. 6B, for each of the cereal product category products (e.g., 625, 630, 635), the respective competitor products (e.g., 665, 670, 675, 680, 685, 690) of the product can be defined (e.g., in one or more business models). The competitor products themselves can also be modeled in respective business models. For instance, the Granola product 665 of competitor Company X, the Corn Flakes product 670 of competitor Company Y, and the Fruit Crunchies product 675 of Company X can be identified as competitor products of the Raisin Bran product 630. The dependency model can model these relationships as well as relationships between corresponding business models. The relationships (e.g., between product 630 and competitor products 665, 670, 675) can be non-hierarchical, in that there is not a one-to-one parent-child relationships. For instance, both product 630 and product 625 each share competitor product 675. Other examples of non-hierarchical relationships within a set of models can also be modeled through dependency models.

As with hierarchical relationships (such as those illustrated in the example of FIG. 6A), a task's (e.g., 655) association with a particular business entity (and corresponding business model) can be extended to other business entities (and corresponding models) based on non-hierarchical relationships between the particular business entities and other entities as defined in one or more business models. As an example, Task A 655 can be associated with the Raisin Bran product 630, and by virtue of the non-hierarchal relationships defined between product 630 and competitor products 665, 670, 675, the task 655 can also be associated with these competitor products 665, 670, 675 and corresponding business models. The propagation of associations between a task (e.g., 655) can extend to several business entities based on chains of relationships identified between business entities in the business models. As an example, as an association is defined between the Granola competitor product 665 and Task A 655, based on the non-hierarchical relationships between product 630 and competitor product 665, the task 655 can be potentially also associated with other products (e.g., 635) based on that product sharing competitor product 665 as one of its competitor products. Additionally, an association between a particular business entity and a task can be extended to associate the task with other business entities, in some cases, based on a combination of hierarchical and non-hierarchical relationships between the particular business entity and other business entities. In some cases, dependency models can be defined to define a substantially complete set of interrelationships between business entities in planning system business models. This can allow data of the models, including associated task data, to be viewed and operated on at varying levels of aggregation.

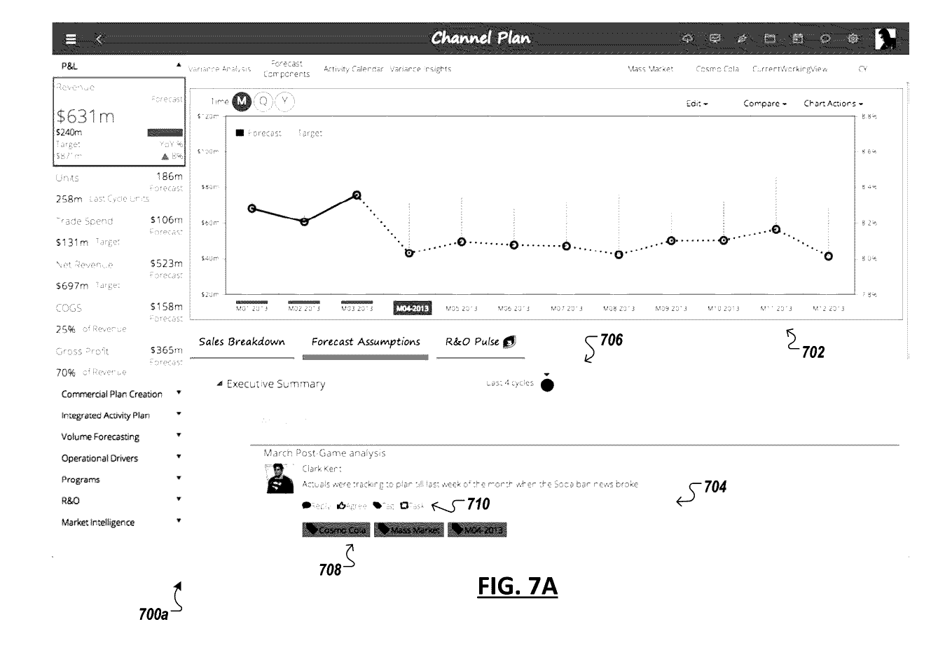

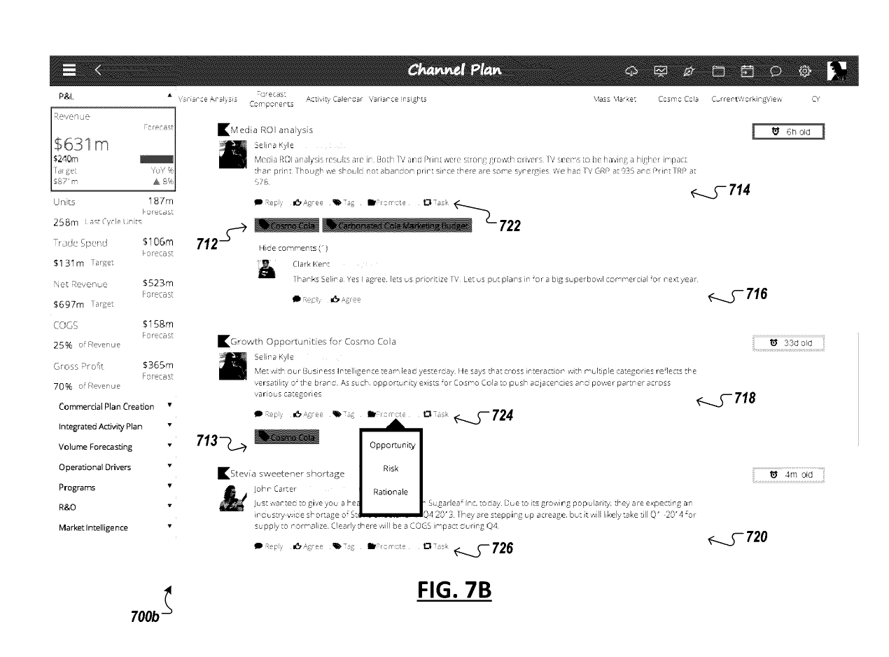

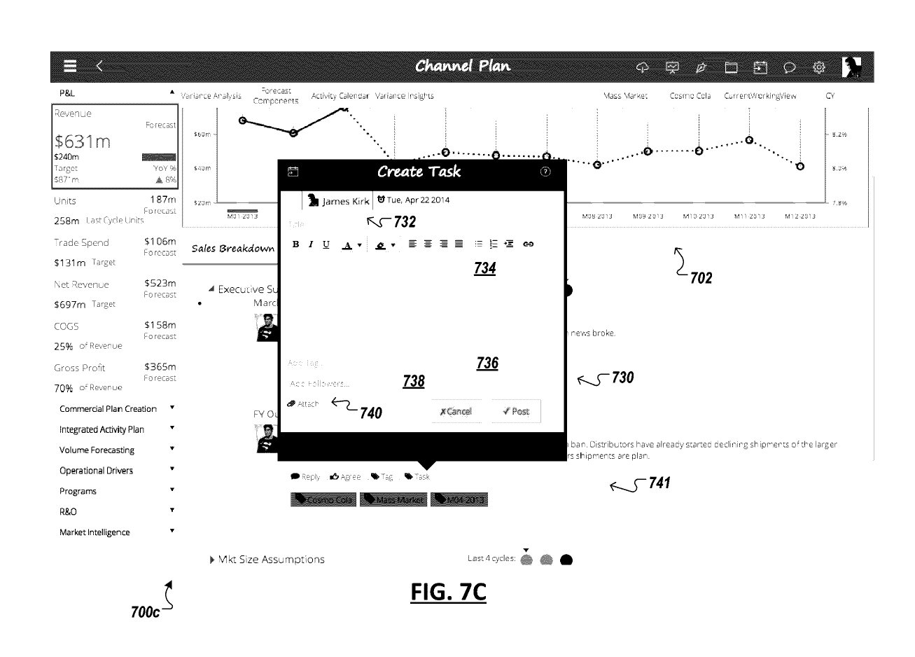

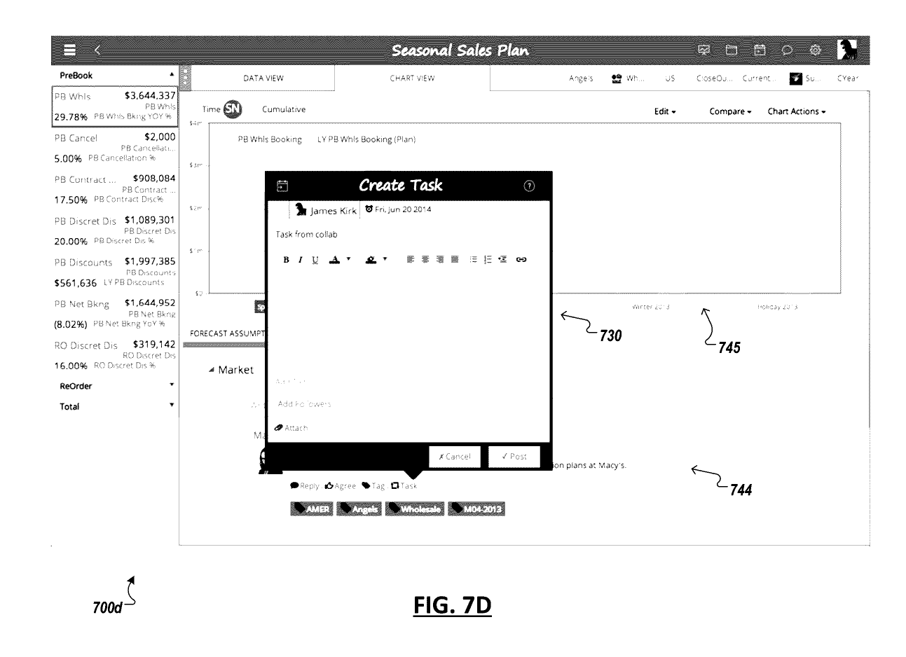

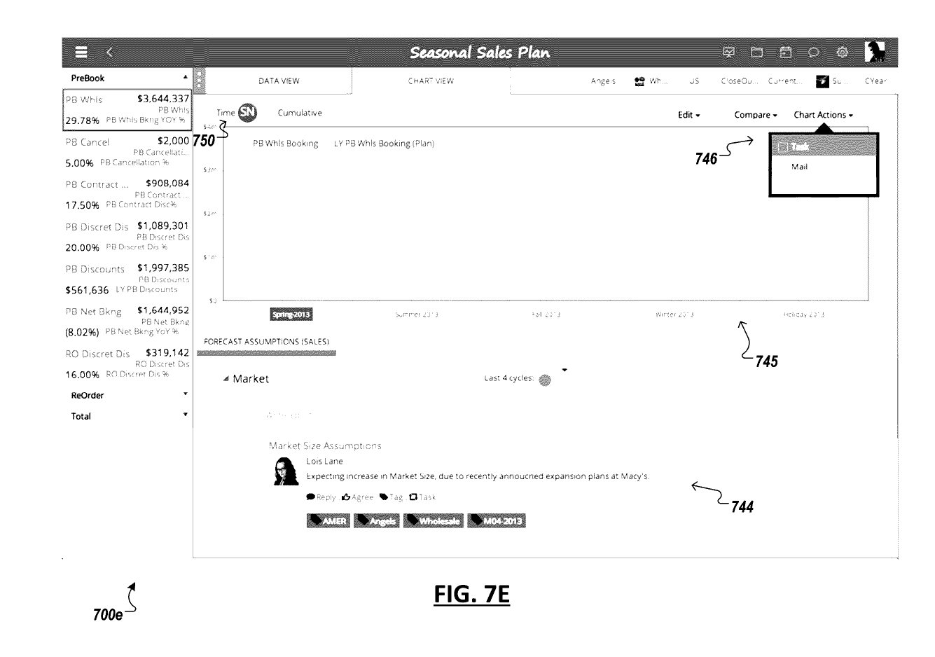

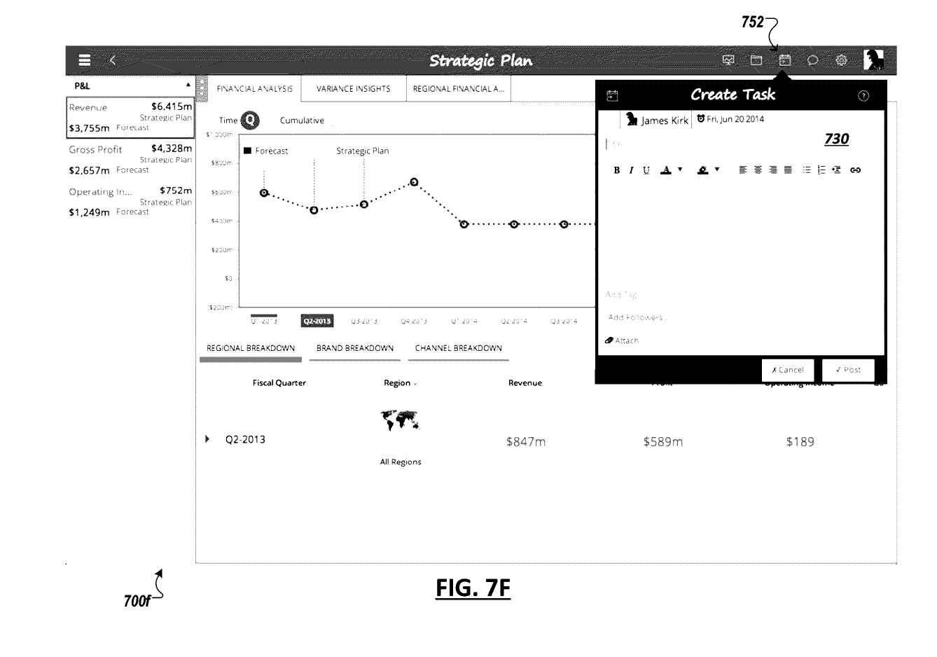

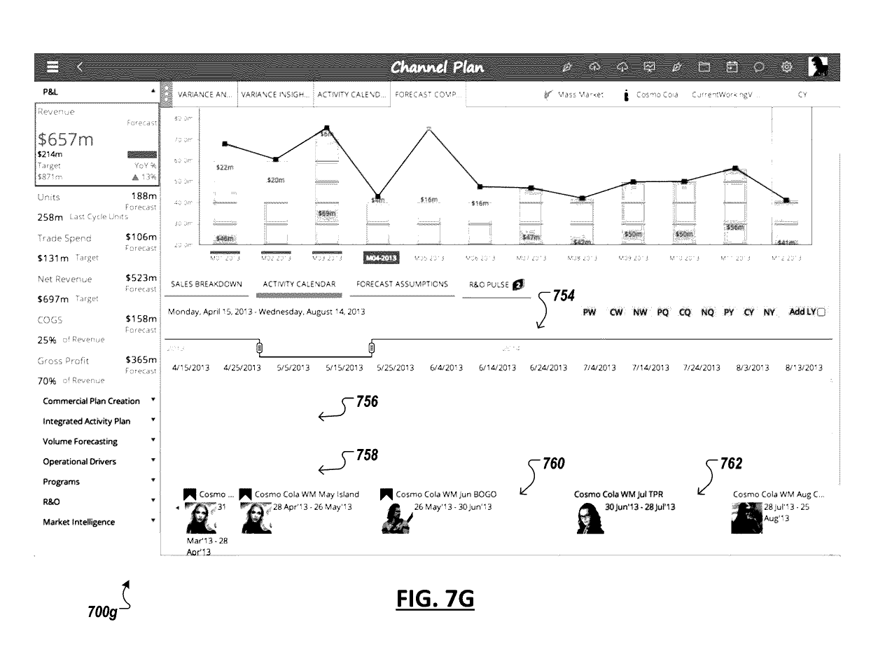

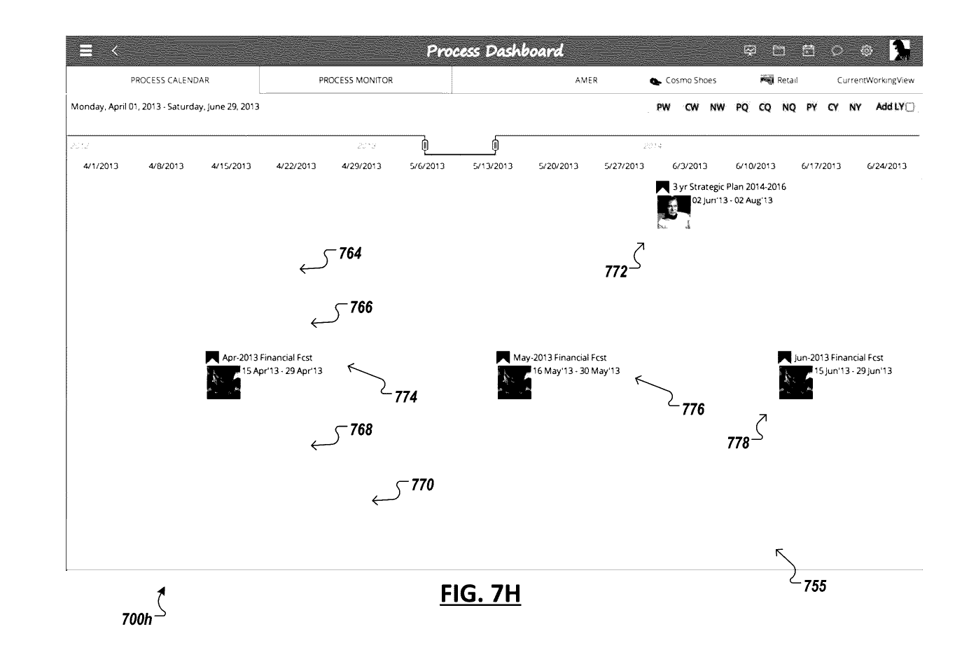

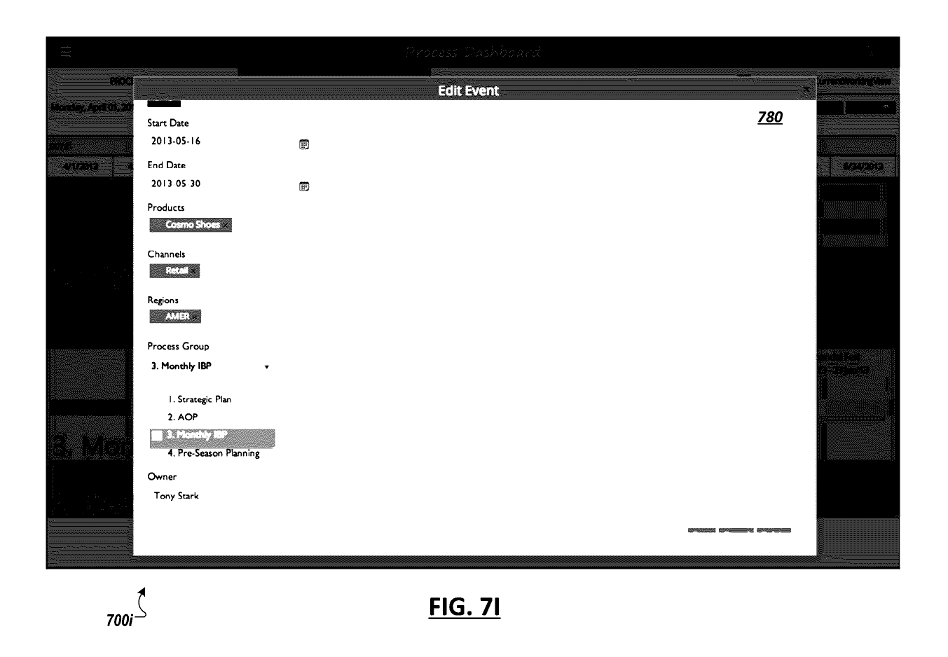

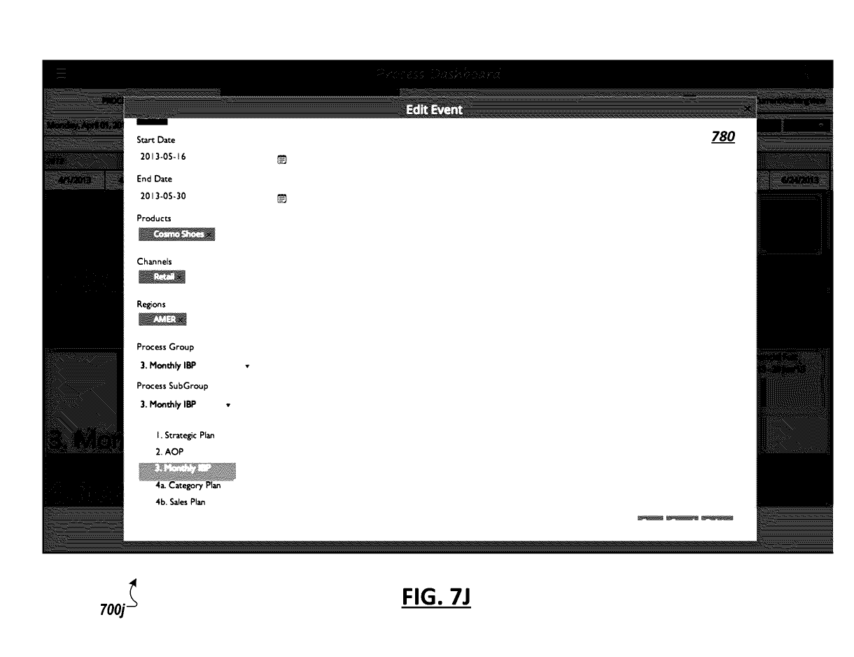

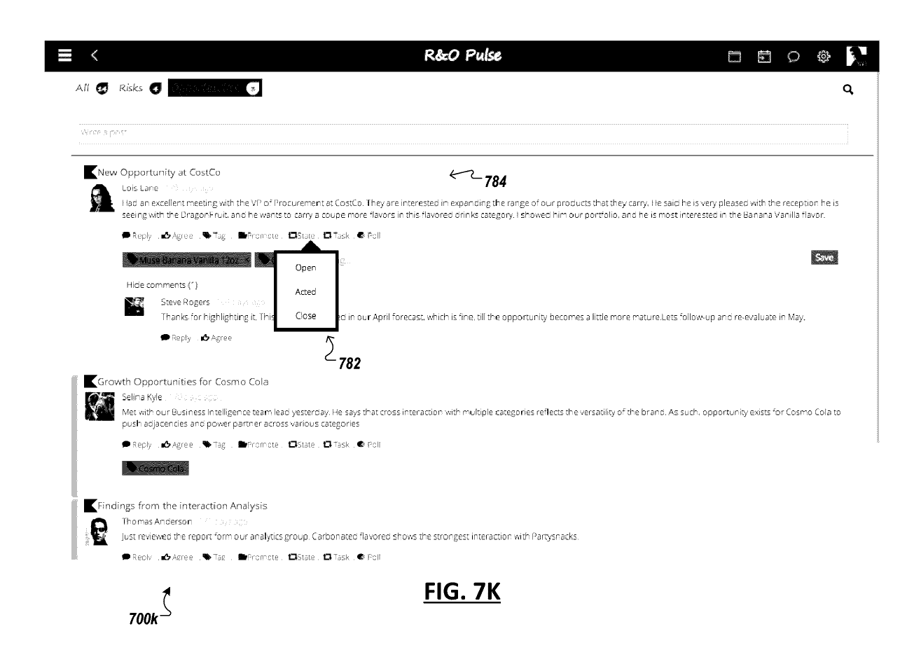

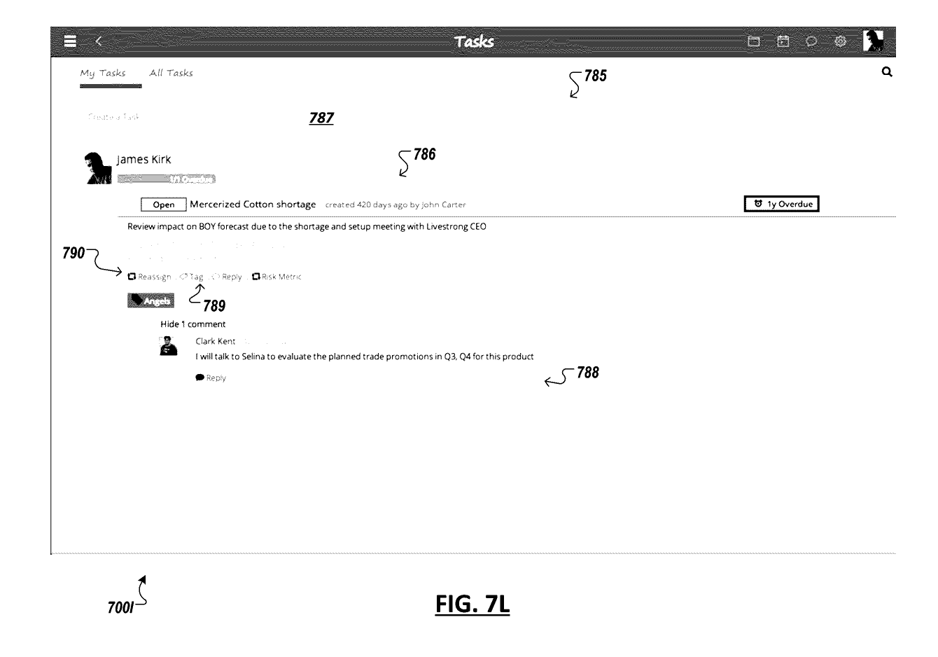

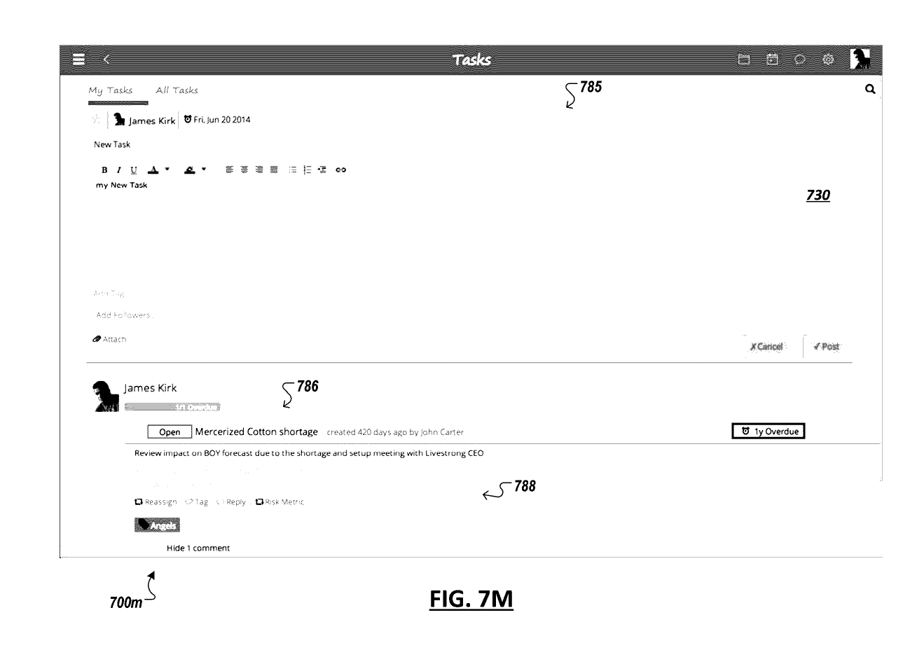

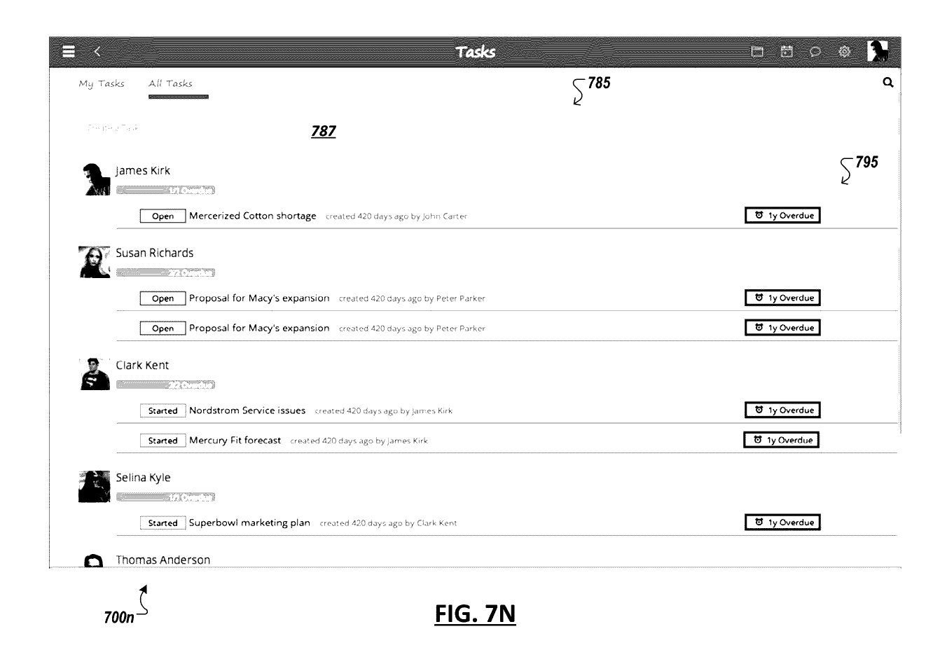

FIGS. 7A-7N are example screenshots 700a-n of user interfaces that can be provided in connection with a discussion system, discussion client (e.g., a dedicated client or web browser used to interface with a web-based discussion system), and/or planning system. It should be appreciated that these screenshots are but illustrative examples and are provided to illustrate additional example features of systems and processes for integrating collaboration and plan modeling. For instance, in the screenshot 700a of FIG. 7A, a user interface is provided that include one or more views (e.g., 702) of a portion of a plan model of an organization. The user interface can also be utilized to navigate between different views of the plan model as well as view other portions of the plan model, or different plan models, among other examples. The user interface can also enable users to edit values within one or more of the business models of the planning system. Other features can also be provided, such as discussion user interfaces (e.g., 704), user feedback tools (such as tools 706 allowing users to provide feedback regarding the accuracy of various assumptions upon which a plan model is dependent, among other examples. Tools can also be provided allowing users to tag discussions, feedback, and plan model views with tags (e.g., 708) that can serve as the basis of associating the feedback, discussions, tasks, etc. with additional, user-designated business entities, among other examples. Indeed, such tags can be selected from a set of tags that are defined based on the business entities modeled in business models of the corresponding planning system. In addition to these visualization and collaboration tools, provided to facilitate planning within an organization based on one or more plan models, user interfaces of the planning system can further facilitate generation, assignment, and management of tasks associated with business entities modeled by the planning engine to permit integration of these tasks with the plan models (and other business models) of the planning system.

User interfaces, such as those in the example of FIG. 7A, can provide one or more tools allowing users to generate, edit, assign, inspect, or otherwise manage tasks associated with planning activities of an organization. For instance, in the example of FIG. 7A, a Task tool 712 can be provided from which to launch one or more other user interfaces or windows to manage associated tasks. A variety of different planning views and tools can be enabled through the user interfaces of a planning system and these various views and user interfaces can further enable the creation and assignment of tasks that can be associated with business models of the planning system. As another example, in FIG. 7B, a screenshot 700b is shown of an example user interface view of a user discussions that can be associated with one or more business models based on parsing of content of the discussions and/or through tagging (e.g., 712, 713) of individual discussion posts (e.g., to indicate that a particular discussion post relates to a particular business entity, etc.). The view can allow a variety of discussion posts (e.g., 714, 716, 718, 720, etc.) to be presented to a user, such as a domain manager. The discussion posts can be displayed, for instance, as a collection of discussion posts from various sources that have been identified (e.g., by the planning system) as related to a particular business entity. Indeed, the set of discussion posts (e.g., 714, 716, 718, 720) can be presented based on a common association with a particular business model. Tasks can also be assigned from this user interface (e.g., through controls 722, 724, 726). In some instances, when a task is generated using a particular one of these controls 722, 724, 726, 728, the task can be automatically associated with the corresponding discussion data as well as business entities associated with the discussion data.

FIG. 7C illustrates an example user interface 730 to create a new task. The interface can include controls (e.g., 732) for selecting a person or group to assign the task to, fields (e.g., 734) for defining the task, controls (e.g., 736) for tagging the task to associate the task manually with additional business entities, as well as other controls. For instance, followers (e.g., persons not directly assigned to perform the task) can be assigned to the task (e.g., through control 738), such as other persons that have an interest in the progress and completion of the task (e.g., a manager, an employee assigned to a related or dependent task, etc.). Further, attachments can be added to the task (e.g., using control 740), among potentially other features for use in defining attributes of the task (such as due date, deliverables, etc.). Some of the user interface controls of an example task creation user interface (e.g., 730) can themselves make use of underlying planning system business models. For instance, the add tags control 736 can be implemented as a provide a dropdown menu or autocomplete text field that makes use of underling business models that effectively catalog the set of business entities modeled by the planning system. Accordingly, this set of business entities can be offered as available tags that can be applied to the task. As another example, assignment control 732 and follower assignment control 738 can also be provided also as a dropdown menu or autocomplete text field, that makes use of business models that identify persons or groups within an organization as well as their roles within the organizations, groups and business units to which they belong, domains that they are associated with, among other examples.

The example of FIG. 7C, shows an example of a task creation user interface (e.g., 730) launched in connection with a discussion 741 identified (e.g., through tags) as related to one or more business entities (e.g., a brand “Cosmo Cola”, a brand category “Mass Market”, and a time dimension “M04-2013”). Indeed, the context in which a task is created can cause corresponding business entity (and thereby business model) associations to be automatically applied to the new task. FIG. 7D illustrates another example of a task created from a user interface 730. In this example, the task creation user interface 730 is launched from a comment 744 corresponding to chart view 745 rendered from a Seasonal Sales Plan plan model. The task created in this example can be associated with the comment 732 and business entities (e.g., “AMER”, “Angels”, “Wholesale”, “M0-2013”), as well as their corresponding business models, including the example Seasonal Sale Plan plan model based on the task being created within this context (e.g., by selecting task control 736). Indeed, the comment 744 itself can be automatically associated with the Seasonal Sales Plan plan or that portion of the Seasonal Sales Plan plan presented in chart view 745, based on the comment being entered as a comment regarding the chart 745. While the create task interface 730 can be substantially similar to the user interface in the example of FIG. 7D, by virtue of the task creation user interface 730 being launched in a different context, different associations can be made between the tasks created from the user interfaces in the distinct examples of FIGS. 7C and 7D.

FIG. 7E shows another example control that can be used to create, edit, and assign tasks. FIG. 7E includes a view 734 of a screenshot 700e similar to that in the example of FIG. 7D, namely a chart view 745 of planning information from at least a portion of a Seasonal Sales Plan plan model. While creation of a task was initiated in connection with a comment 744 regarding the chart view 745 in the example of FIG. 7D, creation of tasks can also be initiated within other contexts, even within the same user interface. For instance, in some implementations, a presentation of a view of information in a plan model, such as a chart view 745 (or data view, map view, etc., among other examples), can also include a control to create a task inspired by or otherwise related to the presentation. For instance, a Chart Actions control 746 can be provided that allows a user to select, among other options, the creation of a task associated with the current view 745. From the context corresponding to the view 745 the task created from selection of control 746 can be associated with one or more business entities and corresponding business models, as well as the plan model upon which the presentation 745 is based. In some instances, a presentation can be interactive, allowing a user to zoom-in/out, scrolls, filter, and otherwise modify the amount and scope of plan model information displayed in the presentation. In such implementations, the precise view within the presentation 745 can be the context for which a task is created in connection with the presentation 745. For instance, a user can interact with the presentation 745 to select particular measures, forecasts, or other values included in the plan model (e.g., Seasonal Sale Plan model) can be selected by a user to be presented within the presentation 745. Further, a user can determine the scope of the presentation, such as a geography or time window (e.g., Spring 2013 to Winter 2013 on a season-by-season basis) (e.g., using Time control 750), to further refine the presentation 745. Based on these selections, in some implementations, any tasks created (e.g., using control 746) while in this specific view can similarly limit or focus the scope of associations made between the task and corresponding business entities, among other examples.

While some tasks can be created in connection with a context such that the task is associated with one or more business models based on that context, a user interface can further provide controls that allow a user to create a task independent of a context. For instance, a control 762 can be provided to allow a user to create a task from a main toolbar of the planning system user interface. Tasks created in response to selecting control 762 can, in this particular example, be context-free in that the task is not automatically associated with any particular plan model or any other business model (or associated business entities). A user can, however, manually assign an association (e.g., through tags) using the task creation user interface. Further, following creation of the task, additional associations with business entities can be identified, manually or automatically, for the task.

While tasks can be generated as one-off, or on-demand, tasks, in other cases, tasks can be generated as repeating or scheduled tasks. In further examples, individual tasks can be grouped in defined projects, or multi-step planning processes (implemented as a series or collection of multiple tasks). AS introduced above, process templates can be provided in some instances to define a project that includes one or more tasks that can be generated automatically in instances of the project. The project template can define characteristics of a corresponding project, including a schedule for the project or tasks within the project, persons, roles, or groups to which the project's various tasks are to be automatically assigned, the amount of time to be given to each task, the dependency of one or more tasks in the project on one or more other tasks in the project (e.g., such that a first task is to be completed before a second task is to be performed), as well as one or more business entities (and corresponding business models) each task in the project is to be associated with. Accordingly, an instance of a project, or process, can be launched either manually by a user or automatically by the planning system (e.g., according to a detected event (within one or more plan models) or a predefined calendar or other schedule) or manually by a user. Launching, or creating, an instance of a project, the class of which is effectively defined in a corresponding process template, can result in the component tasks being auto-generated and, potentially also, assigned to various persons or groups. All or a plurality of the tasks of a project can be generated and assigned substantially simultaneously and in response to the generation of the project instance. The generation of some tasks in the project can also be in response to the generation of the project instance but these tasks can be delayed, in some instances, such as tasks that are dependent on the completion of one or more other tasks, tasks that are conditional on a certain events (e.g., a particular market condition, measure value threshold, or other event detected in and modeled by one or more planning system business models), among other examples.

Turning to FIG. 7G, a screenshot 700g is shown that illustrates a user interface that includes a calendar view 754. A variety of different information modeled in a plan model (and other corresponding business models) can be presented in the calendar view. In some cases, multiple types of information and graphical representations of this information can be presented together in a calendar view. As with other user interfaces of the planning system, a user can interact with the calendar and specify and modify what is presented in the calendar view. For example, in the example of FIG. 7G, the calendar view 754 can pertain to viewing a Channel Plan plan model and the calendar view can include representations 756, 758 of various business units or categories of business initiatives within an organization and the types of initiatives or activities that are planned to be or are active within the respective business units. For instance, some of the activities shown in this example, as represented in the calendar view 754, include planned marketing promotions represented in graphical representations 760, 762 overlaid on the calendar view 754.

Task information can also be overlaid on a calendar view. For instance, a set of tasks that have been associated with business entities modeled in a business model or plan model can be identified and can be presented in a calendar view that corresponds to the business model or plan model, among other examples. In another example, illustrated in FIG. 7H, project instances can also be represented in a calendar view (e.g., 755). For instance, color-coded bands 764, 766, 768, 770 can represent various project instances that have been launched that correspond to various plans modeled by plan models of a planning system. Further, individual tasks (e.g., 772, 774, 776, 778) generated in connection with each of these project instances. For instance, the view of the calendar 754 in this particular example shows a two month period in which a Strategic Plan project includes one or more tasks that have been scheduled within this period (e.g., to begin June 2013 and be completed by August 2013). Similarly, a monthly Integrated Business Plan project can include tasks 774, 776, 778 within this period. The represented tasks 772, 774, 776, 778 can include graphical representations and text to provide an overview of the task, the time for their completion, who they have been assigned to, their status (e.g., overdue, on-track, completed, etc.), among other summary information. Tasks that overlap within a period of time can be shown to overlap in the calendar view. Further, the representations 772, 774, 776, 778 of the tasks can be selectable, allowing a user to inspect and edit the tasks.

Turning to FIG. 7I, a screenshot 700i is shown illustrating a user interface that can be presented, for instance, in response to selecting a task representation (e.g., 772, 774, 776, 778) overlaid in a calendar view (e.g., 755). The user interface 780 in this example can allow a user, such as an authorized user with authority to make changes to individual tasks for a particular corresponding domain. The user can edit an individual instance of a task created according to a process template and in response to the creation of an instance of a corresponding project, or the user can edit the definition of the task within the process template itself. For example, a user can define how the task is to be generated in future instances of the project. For instance, the template can define that a task is to be assigned to a particular start and end date relative to the launch date of the template, the completion of another task in the template, or another event (such as a conditional event detectable in one or more business models of the planning system). The process template can further define rules for automatically assigning the task, such as rules indicating that the task is to be assigned to whichever employee is identified as possessing a certain role within the organization at the time the corresponding project instance is launched, or other employee information. One or more business models can model the employees in an organization, or even the employees related to a particular plan. Such models can model roles or positions of the employees in the organization, as well as other characteristics that can be used to automatically assign users to various tasks according to rules, such as rules defined in process templates for various tasks, among other examples.

The particular example of FIG. 7I show a user interface 780 for editing a task instance that has been generated in accordance with the launch of a corresponding project instance. The various fields of the user interface 780 can be used to modify values of the task, including values that were entered automatically in accordance with the automated generation of the task responsive to the launch of the project instance. As an example, a user, such as a task owner or domain manager (e.g., in charge of managing the task) can modify attributes of a task instance such as changing the person to whom the task is assigned, the start and/or end/due date of the task, as well as various other business entities to which the task relates. For instance, a task can be defined to relate to a particular product, brand, or business unit of an organization, a channel (e.g., retail, online, wholesale, etc.), and a region. The event can even be edited to associate the event with another project instance (or even multiple different project instances). A project can include sub-parts or classifications. For instance, a project can relate to multiple different business initiatives, business units, or even plan models. As shown in FIG. 7J, a user can further associate a task with a subcategory of a Monthly IBP process template, such as by associating this task with a Category Plan, Sales Plan, or other plan incorporated in or associated with the Monthly IBM process template and project instances.

A project instance and its component tasks can be automatically associated with one or more business models (and corresponding business entities), as defined in a corresponding process template. Additional or alternative associations can be made between a project instance and its collection of tasks, or with individual tasks within a project instance. For instance, a user interface can be provided allowing a user to tag or otherwise specify an association to another business entity, and thereby associate the task data with one or more corresponding business models. Further, task management functionality can allow users to provide comments and other feedback regarding generated tasks, including tasks generated from a process template. User provided feedback relating to a task can itself be tagged to associate the feedback with one or more business models, and this association can be extended to the task to which the feedback applies.

Turning to the example of FIG. 7K, tasks and projects can be associated with plans and their corresponding plan models, and the tasks themselves can relate to realizing the goals and objectives of the plans. For instance, accomplishing one or more particular tasks can be a prerequisite to accomplishing one or more objectives of a plan. Tasks can also relate to the monitoring of the progress of these objectives, such as planning activities (e.g., setting goals, checking progress periodically to see if forecasts are being met, providing initial or updated forecasts, addressing gaps between actual and forecasted values, etc.). Accordingly, completing tasks managed by integrated task management logic can result in forward progress of corresponding plans, and this progress can be modeled within corresponding plan models. Accordingly, updates to task data associated with a plan model, including updates indicating that the task as been completed, is behind, or incomplete, can affect the plan model as timely and successful completion of these tasks can be assumptions upon which the plan model is based. Further, planning activities that can be completed through tools of a planning system, such as through user interfaces shown and described in the example of FIGS. 7A-7N (among others), can map to tasks that have been assigned and associated with the planning activities (e.g., through an association with the task and a particular plan model). Accordingly, as the planning activity is completed the status of an associated task can be automatically updated based on the completion of the planning activity. Tasks mapped to planning activities can include, as non-limiting illustrative examples, viewing information of a plan model relating to a forecast or plan progress in user interfaces of the planning system, viewing comments relating to the plan, providing assumption feedback relating to the plan, submitting or updating a forecast for inclusion in the plan model, creating a scenario from the plan model, among many other activities Task status can be identified from other planning system components and features as well. For instance, in the example of FIG. 7K, information in a collaboration, such as information relating to a risk or opportunity, assumption feedback, or other collaboration, can serve as evidence that a task is needed or even that a task has been completed. Accordingly, in some implementations, various views and controls, including discussion tools, can include sub-controls that allow content of the views to be associated with a task and even provide feedback with regard to the status of the task. In the particular example of FIG. 7K, a State tool 782 is provided that allows a user to indicate whether an issue or task is still open, is being acted upon, or has been completed (or closed). The context in which the State tool 782 is selected can cause this context (e.g., a discussion post, chart view, etc.) to be associated with a task as evidence that the status of the task is as indicated by the user through State tool 782, among other examples.

As introduced above, tasks can be associated with users of a planning system. For example, a user can be associated with a task in that they are assigned to complete the task. A user can also follow a task, for instance as a manager, plan or domain owner, etc., to track progress of the task and thereby be associated with the task. User-task associations and the type of these associations can be modeled in a business model, for instance, a model modeling an Employees business entity and/or associated plan models. Additional user interfaces can be provided to allow users to view tasks associated with the user. For instance, FIG. 7L includes an illustration of an example user interface 785 that can serve as a task dashboard for the user. The user interface 785 can include a view 786 of tasks assigned to the user. From here, the user can access the tasks, as well as edit attributes of the task. Depending upon the user's role, the user can be authorized to edit only some portions of the task, such as the current status (e.g., in progress, completed, etc.) of the task. If the assigned user is also the owner of the task (or another higher-level user), the user may be authorized to modify more (or all) attributes of the task, as well as create or delete the task. In this example implementation, comments can be added by the user and other users relating to the task. These comments can also be presented (e.g., at 788) together with the listing of the task. A discussion can thus be follow between two or more users discussing progress and circumstances of the task. Such discussions, like other discussions and collaborations within a planning system, can also result in additional associations with other business entities (e.g., through tag tool 789), causing the task corresponding to the discussion to be further associated with additional business models, among other examples. Additional tools (e.g., 787) can also be provided for additional task management and planning integration functions. For instance, additional tasks can be created by the user (e.g., James Kirk), for instance, through a Create a Task control 787 (as shown further in FIG. 7M), a task can be reassigned (e.g., through control 790), among other examples.

FIG. 7N shows another view 795 of user interface 785 that can be provided for a user to assess tasks identified as associated with the user. The example view 795 can show a view of all tasks associated with the user, including both tasks assigned to the user and tasks followed by the user. Summary information can be presented in the view 795 for each of the tasks. Selecting a particular one of the tasks can cause the user interface to navigate to a detailed view of the task, allowing the user to view additional information for the task, provide comments, as well as edit the task, among other features. Additionally, other controls can be provided to perform related task management activities. For instance, as in view 786, a Create a Task control 787 can also be provided in connection with view 795. Tasks created by a particular user can, in some instances, cause the tasks to be automatically associated with one or more business models or plans. For instance, a user can be identified as an owner of a particular plan or domain and tasks created by the user can be automatically associated with corresponding plan models and/or business models, among other examples.

The systems, processes, and tools can be utilized to provide solutions that integrate information, included in the massive amounts of largely free form communications that occur within, are sent or received by, or that reference an organization, with the planning activities of the organization. Risks and opportunities that potentially effect the organization′ plans can be quickly identified from the content of these communications (or discussion or collaboration data) and connected to these planning activities, including the persons in charge of that planning. Accordingly, such solutions can enable the intelligent propagation and connection of discussions to relevant enterprise plans and the owners of those plans. Additionally, a variety of assumptions are made within the decision making/planning processes of an organization. A planning system can be further equipped with functionality for discovering, from these communications, the knowledge of potentially many persons to inform decision makers and planners of the accuracy of these assumptions (and thereby also the assumptions of their models). These tools can help people participating in the planning process to collaborate within themselves and also seek/solicit inputs from other stakeholders (in some cases in real time) by connecting plans (and exceptions).

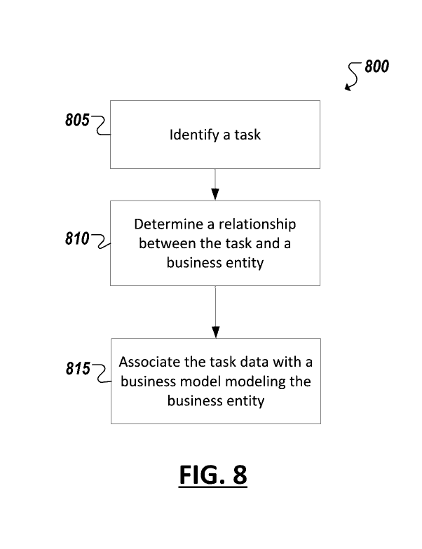

FIG. 8 includes a simplified flowchart 800 illustrating an example technique for integrating plan modeling and task management. In the flowchart 800 of FIG. 8, for instance, task data corresponding to and describing a task can be identified 805. A relationship can be determined 810 between the task and one or more business entities. For instance, a relationship can be explicitly defined in the task data (e.g., by a user during creation or editing of the task), can be determined from the context of the task's creation. Other relationships can be determined associatively based on a relationship between the task and another business entity to which the particular business entity is dependent or otherwise related. The task data can be associated 815 with one or more corresponding business models that model the business entity based on the determined relationship to integrate tasks and task management within the system (including tasks relating to planning activities and goals) with plan modeling and other planning tools and data.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. Systems and tools illustrated can similarly adopt alternate architectures, components, and modules to achieve similar results and functionality. For instance, in certain implementations, multitasking, parallel processing, and cloud-based solutions may be advantageous. Additionally, diverse user interface layouts, structures, architectures, and functionality can be supported. Other variations are within the scope of the following claims.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. A computer storage medium can be a non-transitory medium. Moreover, while a computer storage medium is not a propagated signal per se, a computer storage medium can be a source or destination of computer program instructions encoded in an artificially generated propagated signal. The computer storage medium can also be, or be included in, one or more separate physical components or media (e.g., multiple CDs, disks, or other storage devices), including a distributed software environment or cloud computing environment.

Networks, including core and access networks, including wireless access networks, can include one or more network elements. Network elements can encompass various types of routers, switches, gateways, bridges, load balancers, firewalls, servers, inline service nodes, proxies, processors, modules, or any other suitable device, component, element, or object operable to exchange information in a network environment. A network element may include appropriate processors, memory elements, hardware and/or software to support (or otherwise execute) the activities associated with using a processor for screen management functionalities, as outlined herein. Moreover, the network element may include any suitable components, modules, interfaces, or objects that facilitate the operations thereof. This may be inclusive of appropriate algorithms and communication protocols that allow for the effective exchange of data or information.

The operations described in this specification can be implemented as operations performed by a data processing apparatus on data stored on one or more computer-readable storage devices or received from other sources. The terms “data processing apparatus,” “processor,” “processing device,” and “computing device” can encompass all kinds of apparatus, devices, and machines for processing data, including by way of example a programmable processor, a computer, a system on a chip, or multiple ones, or combinations, of the foregoing. The apparatus can include general or special purpose logic circuitry, e.g., a central processing unit (CPU), a blade, an application specific integrated circuit (ASIC), or a field-programmable gate array (FPGA), among other suitable options. While some processors and computing devices have been described and/or illustrated as a single processor, multiple processors may be used according to the particular needs of the associated server. References to a single processor are meant to include multiple processors where applicable. Generally, the processor executes instructions and manipulates data to perform certain operations. An apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, module, (software) tools, (software) engines, or code) can be written in any form of programming language, including compiled or interpreted languages, declarative or procedural languages, and it can be deployed in any form, including as a standalone program or as a module, component, subroutine, object, or other unit suitable for use in a computing environment. For instance, a computer program may include computer-readable instructions, firmware, wired or programmed hardware, or any combination thereof on a tangible medium operable when executed to perform at least the processes and operations described herein. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Programs can be implemented as individual modules that implement the various features and functionality through various objects, methods, or other processes, or may instead include a number of sub-modules, third party services, components, libraries, and such, as appropriate. Conversely, the features and functionality of various components can be combined into single components as appropriate. In certain cases, programs and software systems may be implemented as a composite hosted application. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, applications may represent web-based applications accessed and executed via a network (e.g., through the Internet). Further, one or more processes associated with a particular hosted application or service may be stored, referenced, or executed remotely. For example, a portion of a particular hosted application or service may be a web service associated with the application that is remotely called, while another portion of the hosted application may be an interface object or agent bundled for processing at a remote client. Moreover, any or all of the hosted applications and software service may be a child or sub-module of another software module or enterprise application (not illustrated) without departing from the scope of this disclosure. Still further, portions of a hosted application can be executed by a user working directly at a server hosting the application, as well as remotely at a client.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), tablet computer, a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device, including remote devices, which are used by the user.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include any internal or external network, networks, sub-network, or combination thereof operable to facilitate communications between various computing components in a system. A network may communicate, for example, Internet Protocol (IP) packets, Frame Relay frames, Asynchronous Transfer Mode (ATM) cells, voice, video, data, and other suitable information between network addresses. The network may also include one or more local area networks (LANs), radio access networks (RANs), metropolitan area networks (MANs), wide area networks (WANs), all or a portion of the Internet, peer-to-peer networks (e.g., ad hoc peer-to-peer networks), and/or any other communication system or systems at one or more locations.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

The following examples pertain to embodiments in accordance with this Specification. One or more embodiments may provide an apparatus, a system, a machine readable storage, a machine readable medium, a method, and hardware- and/or software-based logic (e.g., implemented in connection with a shared memory controller) to identify task data stored in memory of a computing device, the task data describing a task assigned to at least one person in an organization, determine a relationship between the task and a business entity modeled in one or more particular software-based business models in a set of business models, and associate the task data with the particular business model.

In some examples, a request can be received through a user interface presented on a computer device to create the task, and the task data is generated in accordance with the request. The request can be received within a particular context of the user interface and the relationship can be determined based on the context. The context can correspond to a view of at least a portion of information modeled in the particular business model in the user interface, and the portion of information relates to the business entity. The request can be received in connection with a digital discussion corresponding to the context. The request can be received in connection with a graphical presentation of the portion of the information. The request can be received in connection with a graph of data representing the portion of the information. The context can be defined in part from a user tag associated with the context and identifying the relationship.

In further examples, the task may be one of a plurality of tasks included in a project instance. The plurality of tasks may be generated in response to creation of the project instance. The plurality of tasks can be each respectively generated in accordance with a process template, and the process template defines a template for instances of a particular project. The template can define relationships between one or more of the plurality of tasks and one or more respective business entities, and the relationships include the relationship. A start of the task can be dependent on one of a completion of another task in the plurality of tasks and an event detected and modeled in the particular business model. The plan model can represent a respective business outcome expressed as one or more respective outcome measures and includes one or more input drivers representing variables influencing the one or more outcome measures, and a scope model defining a domain of the plan model to which the business outcome applies. A modification to the particular business model can be identified and its can be determined that the modification corresponds to at least a partial completion of the task. The status of the tasks can be updated based on the partial completion. The task can correspond to a planning activity. Business models can include a plan model in a plurality of plan models, and each plan model representing a respective business outcome expressed as one or more respective outcome measures and includes one or more input drivers representing variables influencing the one or more outcome measures, and a scope model defining a domain of the plan model to which the business outcome applies.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described.

Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

The following patent applications are incorporated by reference herein in their entirety as if expressly set forth herein:
U.S. patent application Ser. No. 13/410,222, filed Mar. 1, 2012 and entitled “GLOBAL MARKET MODELING FOR ADVANCED MARKET INTELLIGENCE”; and
U.S. patent application Ser. No. 13/594,723, filed Aug. 24, 2012 and entitled “PLAN MODELING”

What is claimed is:

1. A method comprising:
identifying task data stored in memory of a computing device, the task data describing a task assigned to at least one person in an organization;
determining, using at least one processor device, a relationship between the task and a business entity, wherein the business entity is modeled in one or more particular software-based business models in a set of business models; and
associating the task data with the particular business model.

2. The method of claim 1, further comprising:
receiving a request, received through a user interface presented on a computer device, to create the task; and
generating the task data in accordance with the request.

3. The method of claim 2, wherein the request is received within a particular context of the user interface and the relationship is determined based on the context.

4. The method of claim 3, wherein the context corresponds to a view of at least a portion of information modeled in the particular business model in the user interface, and the portion of information relates to the business entity.

5. The method of claim 4, wherein the request is received in connection with a digital discussion corresponding to the context.

6. The method of claim 4, wherein the request is received in connection with a graphical presentation of the portion of the information.

7. The method of claim 6, wherein the request is received in connection with a graph of data representing the portion of the information.

8. The method of claim 2, wherein the context is defined in part from a user tag associated with the context and identifying the relationship.

9. The method of claim 1, wherein the task is one of a plurality of tasks included in a project instance.

10. The method of claim 9, wherein the plurality of tasks are generated in response to creation of the project instance.

11. The method of claim 10, wherein the plurality of tasks are each respectively generated in accordance with a process template, and the process template defines a template for instances of a particular project.

12. The method of claim 11, wherein the template defines relationships between one or more of the plurality of tasks and one or more respective business entities, and the relationships include the relationship.

13. The method of claim 9, wherein a start of the task is dependent on one of a completion of another task in the plurality of tasks and an event detected and modeled in the particular business model.

14. The method of claim 1, wherein the plan model represents a respective business outcome expressed as one or more respective outcome measures and includes:
one or more input drivers representing variables influencing the one or more outcome measures; and
a scope model defining a domain of the plan model to which the business outcome applies.

15. The method of claim 1, further comprising:
identifying a modification to the particular business model;
determining that the modification corresponds to at least a partial completion of the task; and
updating status of the task based on the partial completion.

16. The method of claim 1, wherein the task corresponds to a planning activity.

17. At least one machine accessible storage medium having instructions stored thereon, the instructions when executed on a machine, cause the machine to:
identify task data describing a task assigned to at least one person in an organization;
determine a relationship between the task and a business entity, wherein the business entity is modeled in one or more particular software-based business models in a set of business models; and
associate the task data with the particular business model.

18. A system comprising:
at least one processor;
at least one memory element; and
a planning system to:
identify task data describing a task assigned to at least one person in an organization;
determine a relationship between the task and a business entity, wherein the business entity is modeled in one or more particular software-based business models in a set of business models; and
associate the task data with the particular business model.

19. The system of claim 18, further comprising:
a task management platform to:
receive a request, received through a user interface presented on a computer device, to create the task; and
generate the task data in accordance with the request.

20. The system of claim 18, wherein the particular business model comprises a plan model, the system further comprises a plurality of plan models, and each plan model represents a respective business outcome expressed as one or more respective outcome measures and includes:
one or more input drivers representing variables influencing the one or more outcome measures; and
a scope model defining a domain of the plan model to which the business outcome applies.
